(19) United States
(12) Patent Application Publication
(10) Pub. No.: US 2026/0289459 A1
(43) Pub. Date: Sep. 24, 2026

(54) SYSTEM

(71) Applicant: SoftBank Group Corp., Tokyo (JP)

(72) Inventor: Tatsuya NAKASHIMA, Tokyo (JP)

(73) Assignee: SoftBank Group Corp., Tokyo (JP)

(21) Appl. No.: 19/564,777

(22) Filed: Mar. 12, 2026

(30) Foreign Application Priority Data
Mar. 19, 2025 (JP) 2025-044984

(51) Int. Cl. G06Q 10/0633; G06Q 30/04

(52) U.S. Cl. CPC G06Q 10/0633; G06Q 30/04

(57) ABSTRACT

A system includes a processor that is configured to receive billing information of a competitor service and store the billing information in a database, analyze the billing information to select, from among a plurality of pricing plans provided by a company, a most economical pricing plan to be proposed, automatically generate a proposal document in a natural language based on a simulation result of the selected pricing plan, by using a natural language processing technique, and generate a prompt sentence for instructing a generative artificial intelligence model to enhance contents of the proposal document.

### CROSS-REFERENCE TO RELATED APPLICATION

This application is based on and claims priority under 35 USC 119 from Japanese Patent Application No. 2025-044984 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional proposal support systems that compare a competitor's billing information with a company's own pricing plans generally require substantial manual work by sales personnel to interpret the competitor's bill, to select an appropriate internal pricing plan, and to draft a persuasive proposal document. As a result, proposal quality heavily depends on the individual skills and experience of each salesperson, leading to inconsistency in proposal accuracy, completeness, and persuasive power. Moreover, when relative discounts must be offered to compete with a competitor's pricing, the creation and submission of internal approval requests are often performed manually, which is time-consuming, error-prone, and may delay the timing of the proposal. In addition, conventional systems typically do not take into account the emotional state or reactions of the user when generating or adjusting proposal content, and therefore cannot dynamically optimize the tone and emphasis of the proposal to match the user's psychological state. Furthermore, although generative artificial intelligence models have the potential to strengthen the quality and persuasiveness of proposal documents, existing systems do not systematically generate prompts to effectively instruct such models based on the underlying billing analysis and simulation results. Accordingly, there is a need for a system capable of: automatically analyzing competitor billing information and selecting the most economical internal pricing plan; automatically generating and enhancing proposal documents using natural language processing and generative artificial intelligence; automatically creating and submitting internal approval requests for relative discounts when necessary; and dynamically adjusting proposal content in response to the analyzed emotions of the user.

### SUMMARY

In order to solve the foregoing problems, a system is provided comprising a processor, wherein the processor is configured to receive billing information of a competitor service and store the billing information in a database, and to analyze the billing information to select, from among a plurality of pricing plans provided by a company, a most economical pricing plan to be proposed. The processor is further configured to automatically generate a proposal document in a natural language, based on a simulation result of the selected pricing plan, by using a natural language processing technique, thereby reducing dependence on individual salesperson skills and improving consistency and efficiency of proposal creation. In addition, the processor is configured to generate a prompt sentence for instructing a generative artificial intelligence model to enhance contents of the proposal document, so that the generative artificial intelligence model can refine, expand, or otherwise strengthen the proposal content in a controlled manner aligned with the underlying analytical results. Furthermore, the processor is configured, when a relative discount is required in view of the competitor's pricing, to automatically generate and transmit an approval request to an internal system in cooperation with the internal system, thereby streamlining internal approval workflows and shortening the time needed to prepare discount-based proposals. Moreover, the processor is configured to analyze an emotion of a user and to dynamically adjust a content of the proposal based on an analysis result of the emotion, for example by modifying the tone, level of detail, or emphasis in the automatically generated and enhanced proposal document, thereby enabling more personalized and psychologically adaptive proposal generation. Through this combination of billing analysis, plan selection, automated natural language proposal generation, prompt generation for generative artificial intelligence, automated approval request handling, and emotion-based content adjustment, the system effectively addresses the aforementioned problems and provides a comprehensive solution for efficient and high-quality proposal creation.

The term “processor” refers to one or more hardware processing units, such as a central processing unit (CPU), a graphics processing unit (GPU), a digital signal processor (DSP), or any combination thereof, capable of executing instructions to perform the functions described in the present disclosure.

The term “billing information of a competitor service” refers to data representing charges issued by a service provider other than the company operating the claimed system, including at least information indicative of monetary amounts charged and optionally including usage metrics, pricing conditions, plan names, discount details, and contract terms.

The term “database” refers to any structured data storage system, including relational databases, NoSQL databases, data warehouses, or other persistent storage mechanisms, configured to store and manage billing information, pricing plan information, proposal documents, and related data for retrieval and processing by the processor.

The term “pricing plan” refers to a predefined set of charging rules and conditions provided by the company, including at least a base fee and optionally including usage-based charges, included allowances, discount conditions, contract periods, and other parameters that determine an amount to be billed to a customer.

The term “most economical pricing plan” refers to a pricing plan selected by the processor from among a plurality of pricing plans such that, according to a predetermined evaluation criterion, the selected plan provides a lowest or otherwise most favorable cost or value to a customer under given billing or usage conditions.

The term “simulation result” refers to information generated by the processor by virtually applying one or more pricing plans to input billing information or usage conditions, the information including at least a calculated charge or fee for each pricing plan, and optionally including comparative metrics among multiple pricing plans.

The term “proposal document” refers to a document generated by the processor that presents to a customer or internal user a recommended pricing plan and related information, and that typically includes at least an explanation of the selected plan, calculated charges, potential savings, and optionally additional descriptive or persuasive content.

The term “natural language processing technique” refers to any computational method or algorithm that processes, analyzes, or generates human language text, including but not limited to tokenization, syntactic and semantic analysis, text generation, summarization, and style adjustment techniques.

The term “generative artificial intelligence model” refers to an artificial intelligence model configured to generate new content, such as text, based on input data or prompts, including but not limited to large language models, transformer-based models, or other generative neural network architectures trained on language data.

The term “prompt sentence” refers to text generated by the processor that is provided as input to a generative artificial intelligence model to instruct or guide the model in generating, enhancing, or modifying content of the proposal document in accordance with predetermined objectives.

The term “relative discount” refers to a discount applied to a pricing plan offered by the company, where the discount is determined or adjusted in relation to a competitor's pricing, such that the resulting charge is made comparable to or more favorable than the competitor's charge.

The term “internal system” refers to an information system operated within the organization of the company, such as an approval workflow system, enterprise resource planning system, customer relationship management system, or other back-office system, with which the processor communicates to manage approval requests.

The term “approval request” refers to electronic data generated by the processor that requests authorization for a particular action, such as granting a discount or applying a specific pricing plan, and that is transmitted to an internal system for review, approval, or rejection according to internal rules.

The term “emotion of a user” refers to an affective or psychological state of a user, such as satisfaction, dissatisfaction, interest, confusion, or hesitation, inferred or estimated by the processor using one or more inputs, including textual input, voice, facial expressions, interaction patterns, or other behavioral indicators.

The term “analyze an emotion of a user” refers to processing, by the processor, input data associated with the user in order to estimate or classify the user's emotional state according to one or more predefined emotional categories or continuous emotional scales.

The term “dynamically adjust a content of the proposal” refers to modifying, by the processor, at least part of the text or structure of the proposal document during or after generation, in real time or near real time, based on changing conditions such as a user's emotional state, to alter tone, level of detail, emphasis, or included information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

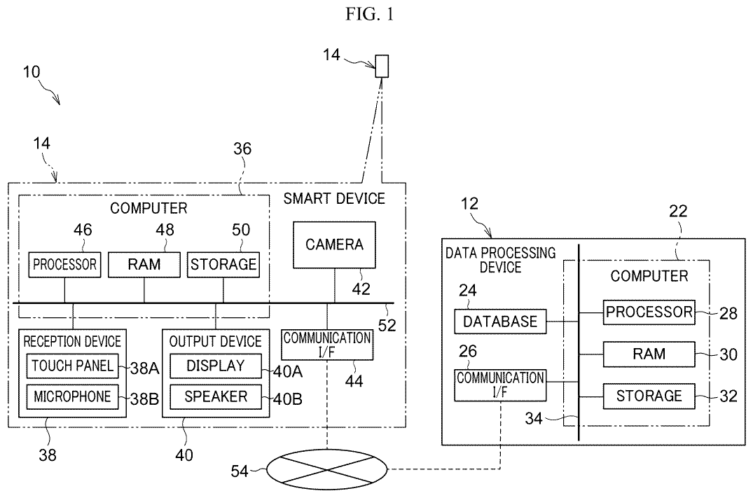

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

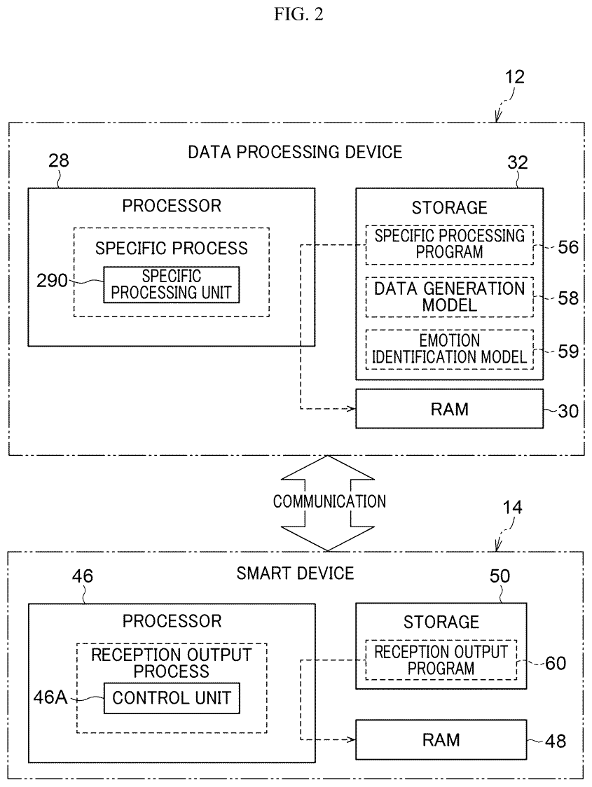

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional systems for proposing internal rate plans based on external provider billing information typically rely on fragmented processing flows and static templates. A server may merely store billing information in a database and execute simple rule-based comparisons, leaving substantial manual work to human operators. In particular, conventional systems often (i) require custom scripting or spreadsheet operations to simulate multiple internal rate structures, (ii) depend on rigid, pre-authored document templates that do not adapt to individual user conditions, and (iii) are not architected to leverage generative AI models in a controlled manner for generating proposal content. As a result, proposals are slow to prepare, inconsistent in quality, and difficult to scale across large user populations. From a computer technology standpoint, existing architectures do not integrate numerical computation components, electronic document generation components, and generative AI models into a coordinated pipeline that is orchestrated by a processor according to a well-defined set of data structures and control flows. First, fee simulation is often implemented as ad hoc business logic spread across multiple subsystems, causing redundant database access, increased latency, and poor maintainability. Second, proposal documents are frequently generated on client devices or by manual desktop tools, which prevents the use of centralized optimization and makes it difficult to ensure that the same computation results are reflected consistently across all outputs. Third, when generative AI models are used at all, they are typically invoked in an unstructured way, with free-form prompts manually crafted by users, making it hard to enforce compliance, traceability, and reproducibility of generated explanations.

Furthermore, known systems do not exploit user response information and emotional state analysis to dynamically adapt both the prompts issued to a generative AI model and the structure of the generated proposal document. The absence of this feedback loop means that the system cannot automatically tailor the depth, tone, or emphasis of explanations to the user's inferred emotional state, resulting in suboptimal user understanding and engagement. Additionally, conventional discount-approval workflows for exceptional or relative discounts are often disconnected from the plan simulation logic, requiring manual preparation and submission of approval requests in a separate internal system, thereby introducing delay and risk of human error.

Accordingly, there is a need for an improved computer-implemented system that tightly integrates (i) centralized receipt and storage of external billing information, (ii) high-performance numerical computation for fee simulation across multiple internal rate structures, (iii) automated generation of structured proposal documents in an electronic format, and (iv) controlled interaction with a generative AI model through programmatically generated prompt sentences. There is also a need for such a system to programmatically generate and transmit approval request documents when a relative discount is required, and to exploit user response information and emotion analysis to dynamically adjust both prompts and proposal structures. Such improvements would enhance the technical functioning of the server, reduce overall processing latency, improve resource utilization, and increase consistency and quality of generated proposal outputs.

The specific processing by the specific processing unit 290 of the data processing device 12 in Example 1 is realized by the following means.

The present invention provides a server comprising a processor configured to receive, via a communication interface, charge information relating to a service provided by an external provider from a user terminal, record the charge information in an information management mechanism in an information storage device, acquire the recorded charge information together with a plurality of rate structure information items relating to services provided by an internal provider, perform, by using a numerical computation program group, fee calculation for each of the plurality of rate structures and identify, by comparison with a fee of the external provider based on the charge information, a rate structure that is most economical for the user, generate configuration information of a proposal document based on the identified rate structure and a result of the fee calculation, output, by using an electronic document generation program group, the proposal document in an electronic format, generate, based on the charge information, the result of the fee calculation, and the identified rate structure, a prompt sentence including instruction content for a generative information processing model, input the prompt sentence to the generative information processing model so as to cause the generative information processing model to generate explanatory text or recommendation content and incorporate the explanatory text or the recommendation content into the proposal document, transmit the proposal document in the electronic format to the user terminal, and, when it is determined from the result of the fee calculation that a relative discount process is required, automatically generate and transmit an approval request electronic document to an internal business processing mechanism, and further analyze user response information acquired via the user terminal to estimate an emotional state of the user and dynamically adjust at least one of the prompt sentence and the configuration information of the proposal document based on a result of the estimation. This enables an integrated, server-centric processing pipeline that improves computational efficiency and consistency of rate simulations, automates generation and enhancement of proposal documents using a generative AI model under programmatic control, seamlessly links discount approval workflows with simulation results, and adaptively tailors both prompts and document structures to the user's inferred emotional state, thereby improving the overall technical performance and scalability of the computer-implemented proposal system.

The term “processor” refers to a hardware or virtual processing unit, such as a central processing unit or an execution core in a computing device, that executes instructions of one or more programs to perform the described functions of the system.

The term “terminal” refers to an information processing device operated by a user, such as a mobile device, a personal computer, or a smart appliance, that transmits data to and receives data from the server via a communication network.

The term “user” refers to a human operator or customer who interacts with the terminal to provide information, receive proposal documents, and review or respond to recommended rate structures.

The term “external provider” refers to an organization or entity other than the internal provider that offers services for which charge information, such as billing amounts and usage conditions, is generated.

The term “internal provider” refers to an organization or entity associated with the system that offers services and a plurality of rate structures to be compared against charge information of the external provider.

The term “charge information” refers to information relating to fees and usage conditions of a service provided by the external provider, including, for example, billing amounts, data usage quantities, voice call durations, and billing periods.

The term “information storage device” refers to a hardware storage resource, such as a magnetic disk, a solid-state drive, or a non-volatile memory, that stores charge information, rate structure information, proposal documents, and related data.

The term “information management mechanism” refers to a software-based data management component, such as a database management system or a data store controller, that stores, retrieves, updates, and manages charge information and rate structure information on the information storage device.

The term “rate structure information” refers to information defining a fee schedule of the internal provider, including parameters such as base fees, included usage amounts, overage conditions, and unit prices for additional usage.

The term “rate structure” refers to a pricing configuration of the internal provider that determines how user fees are calculated based on usage, including a combination of base charges and variable charges.

The term “numerical computation program group” refers to one or more software components or libraries that perform arithmetic, statistical, or other numerical operations to calculate fees and perform comparisons across multiple rate structures.

The term “fee calculation” refers to a computational process in which the processor applies one or more rate structures to the charge information, or corresponding usage conditions, to obtain estimated or simulated fees for the internal provider's services.

The term “most economical” refers to a condition in which a particular rate structure yields a fee that is lower than or otherwise more cost-effective for the user than other candidate rate structures when applied to the same usage conditions.

The term “proposal document” refers to an electronically generated document that presents at least one recommended rate structure, simulated fee results, comparisons with external provider fees, and explanatory or recommendation content for the user.

The term “configuration information of a proposal document” refers to structural and content definition data for the proposal document, including arrangement of sections, tables, text elements, and formatting parameters to be used in generating the electronic document.

The term “electronic document generation program group” refers to one or more software components or libraries that generate an electronic document, in formats such as a portable document format or other structured document formats, based on configuration information and content data.

The term “generative information processing model” refers to an information processing model, such as a machine learning model or a generative AI model, that generates text or other content in response to input data including a prompt sentence.

The term “prompt sentence” refers to a text string or structured textual input that encodes instructions, context, and parameters to be provided to the generative information processing model in order to request generation of explanatory text or recommendation content.

The term “explanatory text” refers to text generated or selected by the system that explains reasons for recommending a particular rate structure, including cost comparisons, usage assumptions, and benefits for the user.

The term “recommendation content” refers to text or structured information that explicitly suggests one or more rate structures to the user, including indications of preferred plans, savings amounts, or advantages over alternative options.

The term “communication interface” refers to a hardware and software combination that enables the processor to exchange data with the terminal and other systems over a communication network using one or more communication protocols.

The term “communication process” refers to operations performed by the processor and the communication interface to transmit and receive data, such as charge information and proposal documents, between the server and the terminal.

The term “internal business processing mechanism” refers to a software or system component used within an organization to manage internal workflows, including approval processes, record keeping, and routing of approval request documents.

The term “relative discount process” refers to a discount determination and application procedure in which a price reduction, special rate, or exception is applied relative to a standard rate structure in order to achieve a desired fee or savings for the user.

The term “approval request electronic document” refers to an electronically generated document that requests authorization from an internal authority or system to apply a relative discount process or other exceptional pricing measure.

The term “user response information” refers to information obtained from the user via the terminal after or during presentation of a proposal document, including explicit feedback, selections, navigation behavior, or other interaction data.

The term “emotional state” refers to an inferred condition of the user's affect or sentiment, such as satisfaction, confusion, interest, or hesitation, estimated based on user response information using emotion analysis processing.

The term “emotion analysis processing” refers to a computational procedure that analyzes user response information, such as textual input, interaction patterns, or other behavioral signals, to estimate the emotional state of the user.

The term “dynamically adjust” refers to modifying, at runtime and in response to changing conditions such as user emotional state or updated calculations, at least one of a prompt sentence or configuration information of a proposal document without requiring manual reauthoring of the underlying software.

The term “electronic format” refers to a digital representation of a document that can be stored, transmitted, and displayed by electronic devices, including but not limited to portable document format files, hypertext documents, or other machine-readable formats.

In one embodiment, a server, a terminal, and a network are configured to implement the claimed system. The server includes at least one processor, a main memory, a non-volatile storage device, and a network interface. The processor may be a general-purpose central processing unit or a multicore processor. The storage device may be a solid-state drive or a magnetic disk. The network interface provides connectivity to a communication network, such as the Internet or a mobile data network. The server executes a server program stored in the storage device and loaded into the main memory.

The terminal includes a processor, a memory, a display, an input device, and a communication interface. The terminal may be implemented by a smartphone, a tablet, or a personal computer. The terminal executes a client program, such as a web browser or a dedicated application, to allow a user to input external charge information and to receive and display a proposal document.

The server uses an information management mechanism, for example a relational database management system such as a structured query language database engine, to store charge information and rate structure information. The server also uses a numerical computation program group, for example a numerical library in a high-level language runtime, to perform vectorized fee calculations. The server further uses an electronic document generation program group, for example a portable document format generation library, to create proposal documents in an electronic format. The server additionally uses a generative AI model, which may be a transformer-based neural language model, to generate explanatory text and recommendation content based on a prompt sentence constructed from the computed results. The server records charge information received from the terminal in a structured data schema. The server may define, in the database, a table for external charge records with fields such as an identifier of a user, a billing period, a total billing amount, a data usage quantity, a voice call duration, and optional service attributes. The server also defines a table for internal rate structures, with fields such as a plan identifier, a base fee, included data usage, included voice minutes, data overage unit price, and voice overage unit price. The server stores in this table multiple rate structures that correspond to different internal service offerings.

The server uses the numerical computation program group to transform raw charge information and rate structure parameters into a form suitable for efficient computation. The server converts lists of plan parameters into dense numerical arrays and performs element-wise operations to compute, for each plan, an overage usage amount and a corresponding fee component. The server uses operations such as maximum, addition, and multiplication on arrays to derive a total simulated fee for each plan. By using a vectorized numerical library, the server reduces the number of loop iterations that the processor executes, decreases cache misses, and improves throughput when processing many plans and many users, compared to a naive scalar implementation.

The server identifies a most economical rate structure by comparing the computed simulated fees. The server analyzes the array of simulated fees and determines an index of a minimal value. The server then selects the rate structure associated with this index. The server optionally computes a savings amount for each plan by subtracting the simulated fee from the external billing amount. The server stores the computed fees, the index of the recommended plan, and the savings amounts in a structured result object that is maintained in the memory and may be persisted in the database.

The server generates configuration information for a proposal document based on the structured result object. The server constructs an internal representation of the document, for example, a list of sections, each section containing headings, paragraphs, and tables. The server defines a section summarizing the external charge information, a section listing each internal rate structure with its simulated fee and savings, and a section highlighting the most economical rate structure. The server passes this configuration information, together with numeric values, to the electronic document generation program group.

The server invokes the electronic document generation program group to render the proposal document into a portable document format file. The server sets document metadata such as a title, an author field, and a generation timestamp. The server renders tables by placing textual cells and drawing lines at computed positions in a page coordinate system. The server renders explanatory text and recommendation content into text boxes that are wrapped according to the page width and font metrics. The server writes the binary representation of the electronic document into memory so that it can be transmitted to the terminal.

The server uses a generative AI model to generate explanatory text and recommendation content that are tailored to the user's external charge information and the computed simulation results. In one embodiment, the generative AI model is a neural network employing a transformer architecture with multiple self-attention layers, feed-forward layers, and layer normalization. The model is trained on large corpora of textual data using an unsupervised language modeling objective, such as next-token prediction, with a cross-entropy loss function. The model includes a vocabulary embedding layer, positional encodings, multi-head attention modules, and output projection to the vocabulary space. The model parameters, such as weights and biases, are optimized during training by a gradient-based optimizer, such as an adaptive learning rate algorithm. The model thus encodes statistical relationships between input tokens and output tokens.

The server constructs a prompt sentence to control the generative AI model in a non-abstract and reproducible manner. The server concatenates static template phrases with dynamic fields that are populated from the computed results. For example, the server may construct the following prompt sentence:

“If a customer is currently paying 10,000 yen per month to another company for mobile service, and our Plan A costs 8,000 yen per month while our Plan B costs 9,000 yen per month under the same usage conditions, please explain which of our plans is the most economical option and describe, in clear and polite language, how much the customer can save and why the recommended plan is advantageous.”

The server may generate similar prompt sentences in different languages or with different detail levels, but the server always includes specific numeric values and plan identifiers. The server thus imposes a structured interface between the deterministic numerical computations and the generative AI model, ensuring that the output explanation remains grounded in the computed data.

The server provides to the generative AI model not only the prompt sentence but also auxiliary features, such as a label indicating a desired tone, a maximum length parameter, or a field specifying whether the explanation should emphasize savings or service quality. The generative AI model processes the prompt sentence by encoding each token into a high-dimensional vector, propagating the vectors through the transformer layers, computing attention scores among tokens, and generating probability distributions for successive output tokens. The model generates a sequence of output tokens according to the learned probability distributions, subject to constraints such as a maximum token length and stop conditions. The server decodes the token sequence into text and post-processes the text, for example by removing incomplete sentences or by verifying that the text includes required elements such as a numeric savings amount.

The server improves computer technology by using this structured prompt mechanism in combination with the numerical computation and document generation pipeline. Because the server constructs prompt sentences programmatically from exact numerical results, the generative AI model produces explanations that reflect precise computations, reducing the need for manual editing. The server also minimizes the number of tokens used in the prompt sentence by encoding information in a compact but structured way, which reduces network bandwidth usage between the server and any remote generative AI service and reduces the computation time of the generative AI model itself.

The server further uses an internal business processing mechanism to handle relative discount processes. When the numerical computation results indicate that a target simulated fee cannot be met without applying a discount beyond standard parameters, the server determines that a relative discount process is required. The server then generates an approval request electronic document including fields such as a user identifier, a recommended rate structure identifier, a proposed discount amount, and justification based on the computed savings and external billing information. The server transmits this approval request electronic document to the internal business processing mechanism, which may be implemented by a workflow management system. This integration reduces the need for human operators to extract data manually from multiple systems and significantly shortens the delay between detection of a discount requirement and initiation of an approval process. Because the server reuses the same structured computation results, approval documents and proposal documents remain consistent, reducing data discrepancies and errors.

The server also acquires user response information via the terminal. The terminal displays the proposal document and collects interaction signals such as selection of additional details, time spent on particular sections, or explicit natural language queries entered by the user. The terminal transmits these signals to the server as response information. The server performs emotion analysis processing on this response information. For instance, when the response information includes natural language text entered by the user, the server processes the text by tokenizing it, mapping tokens to sentiment scores based on a trained sentiment classification model, and aggregating those scores over the text. When the response information includes interaction metrics, such as extended viewing time on a section labeled “concerns” or repeated expansion of a “risk” section, the server interprets these patterns according to predefined rules to infer possible confusion or hesitation.

In one embodiment, the server uses a separate neural network classifier to estimate an emotional state from text-based user responses. The classifier may be implemented as a smaller transformer or as a recurrent neural network with an embedding layer and an attention mechanism. The classifier is trained on labeled data, where sample texts are associated with emotional labels such as “positive,” “neutral,” “confused,” or “anxious.” During training, the classifier minimizes a loss function, such as categorical cross-entropy, and updates its parameters by gradient descent. At runtime, the server feeds tokenized user text into the classifier, obtains a probability distribution over emotional labels, and selects the label with the highest probability as the estimated emotional state.

The server uses the estimated emotional state to dynamically adjust at least one of the prompt sentence and the configuration information of the proposal document. For example, when the estimated emotional state indicates confusion, the server modifies the prompt sentence to request a more detailed explanation with simpler terminology. The server may generate a prompt sentence such as:

“The customer seems confused about the price difference between the current plan and the recommended plan. Please re-explain the recommendation using simple terms, focusing step-by-step on how the monthly fee is calculated and how much can be saved.”

When the estimated emotional state indicates satisfaction, the server may generate a shorter, more confirmatory explanation. By adjusting the prompt sentence, the server causes the generative AI model to produce different output patterns that better match the user's state, while still being constrained by the same numerical results and technical configuration. The server also modifies the document configuration based on the emotional state. When confusion is detected, the server may adjust the document layout to include additional intermediate tables that show each component of the fee calculation, and may increase the font size of explanatory headings. When interest is detected, the server may insert additional optional sections, such as projections over longer time horizons or comparisons among multiple alternative plans. These adjustments are implemented programmatically by altering the internal configuration object before passing it to the electronic document generation program group, which results in different electronic document outputs without changing the underlying code base.

The described architecture improves the functioning of the computer itself. By centralizing numerical computations using a dedicated numerical library, the server reduces redundant operations, better utilizes vectorized instruction sets, and lowers overall processing time when simulating many rate structures. By using a structured document configuration and a specialized document generation library, the server prevents inconsistent rendering between clients and ensures that all numerical results are faithfully reflected in the generated documents, thereby reducing logical errors. By coupling the generative AI model with programmatically constructed prompt sentences and by enforcing grounding in stored computation results, the server prevents the generative AI model from generating content that is unrelated to the underlying data, which improves reliability and reduces the need for manual quality control. By incorporating emotion analysis, the server adaptively optimizes the length and content of the generated text and the document structure, which reduces unnecessary data transmission and repeated requests from the user, thus lowering communication load.

In another embodiment, the server may host the generative AI model locally instead of accessing a remote model. In that case, the server stores the model parameters on the storage device and executes the model on the processor or on a dedicated accelerator, such as a graphics processing unit. The server allocates memory buffers for input token sequences and for output token sequences, and performs inference by repeatedly applying the transformer layers to the input representation. The server may quantize the model weights to reduce memory usage and accelerate computation, and may batch multiple prompt sentences for different users to improve throughput. This embodiment further enhances technical efficiency by minimizing latency due to external network calls.

In a further embodiment, the server may use alternative numerical computation program groups, such as a matrix computation engine optimized for multi-threaded execution, or may offload intensive computations to a coprocessor. The server may also use alternative document formats, such as hypertext markup documents rendered by the terminal, while still applying the same principles of centralized configuration and generation. The server may support multiple internal providers or multiple categories of services, by parameterizing the rate structure table and extending the schema to include service type identifiers. The core mechanisms for numerical simulation, prompt construction, generative AI invocation, emotion analysis, and document generation remain the same.

The terminal may be implemented in different forms. In one form, the terminal executes a browser that communicates with the server using hypertext transfer protocols and renders proposal documents using a built-in document viewer. In another form, the terminal executes a dedicated application that caches some configuration metadata locally and requests only updated numeric content and generative AI explanations from the server, further reducing communication volume. In yet another form, the terminal may be a kiosk device in a retail location, where a user interacts with a touch panel to enter charge information and retrieve printed proposal documents generated by the server and rendered via a printing device. Through these embodiments, the server, terminal, and associated software components implement a specific technical configuration that goes beyond a mere automation of a business practice. The integration of specialized numerical computation, structured data storage, controlled generative AI invocation via prompt sentences, automated discount approval document generation, and emotion-based dynamic adjustment of prompts and document structures produces concrete technical effects, such as improved processing speed, increased accuracy and consistency of simulated fees, reduced manual error, optimized network usage, and enhanced adaptability of content generation to user state. As a result, the system improves the operation of the computer-based proposal environment itself.

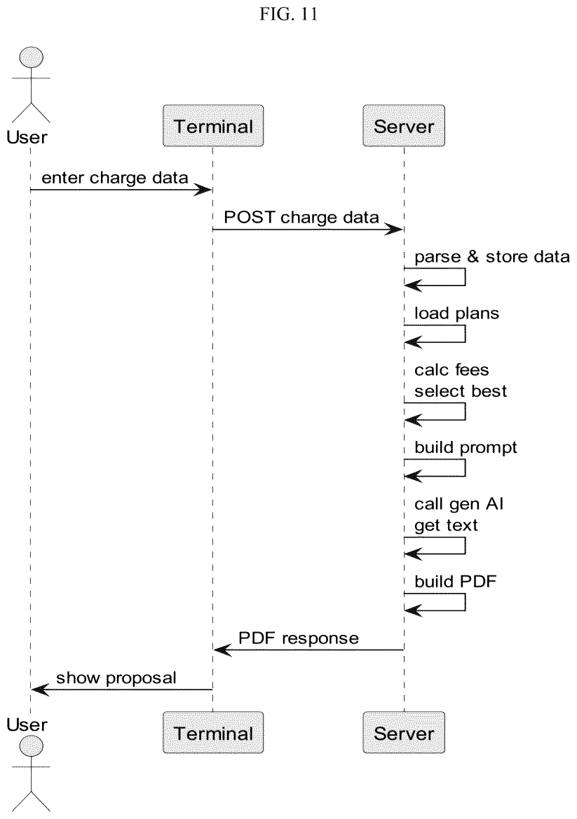

The following describes the processing flow using FIG. 11.

Step 1:

The user operates the terminal and opens an application screen for plan simulation.

The terminal displays input fields for external monthly charge, data usage, call duration, and other usage conditions.

The user inputs values such as “monthly bill 10,000 yen, data 20 GB, calls 60 minutes” and confirms the input.

The terminal takes, as input, the user-entered values in user interface components, validates that mandatory fields are filled and that numeric fields contain valid numbers, and converts the values into an internal data structure such as a key-value map.

The terminal serializes this internal data structure into a request payload, for example a JSON object, and outputs an HTTPS request message containing the payload addressed to the server's endpoint.

Step 2:

The server receives the HTTPS request from the terminal via a network interface.

The server takes, as input, the request message including the serialized charge information, parses the HTTP headers and body, and decodes the JSON payload into a server-side data structure such as a dictionary or record object.

The server validates the decoded data by checking required keys (external bill amount, data usage, call minutes), numeric ranges, and data types, and outputs a normalized charge information object that will be used in subsequent processing.

The server logs the receipt of the request, including a timestamp and a temporary request identifier, to a log store.

Step 3:

The server stores the normalized charge information object into an information management mechanism, such as a relational database.

The server takes, as input, the normalized charge information object and maps its fields to columns in an external charge table, for example user identifier, billing period, billing amount, data usage, and call duration.

The server generates an insert command in a structured query language, sends the command to the database engine via a database driver, and causes the database engine to write a new record to persistent storage.

The server receives, as output from the database engine, a primary key value for the newly inserted record, and stores this primary key in memory as a reference to link subsequent computations to the stored external charge information.

Step 4:

The server acquires internal rate structure information from the database in preparation for fee calculation.

The server takes, as input, a request to retrieve all active rate structures applicable to the service type associated with the external charge, and issues a select command to the database engine.

The server receives, as output, a result set including multiple records, each record representing a rate structure with parameters such as base fee, included data volume, included call minutes, and overage unit prices.

The server converts the result set into a structured in-memory representation, such as arrays or lists of numerical parameters, and aligns units (for example converting all data usage values to a common unit) so that subsequent computations can be applied uniformly.

Step 5:

The server performs numerical fee calculations for each internal rate structure using a numerical computation program group.

The server takes, as input, the normalized external charge information (for example, external data usage and call minutes) and the arrays or lists of rate structure parameters.

The server computes, for each rate structure, an overage data amount by subtracting the included data from the external data usage and setting negative values to zero, and computes an overage call amount in a similar manner for call minutes.

The server multiplies the overage data amount by the corresponding data overage unit price and the overage call amount by the corresponding call overage unit price, and then adds the base fee to obtain a simulated internal monthly fee for each rate structure.

The server aggregates these simulated fees into a numerical array as an output, and associates each simulated fee with its corresponding rate structure identifier.

Step 6:

The server identifies the most economical rate structure based on the simulated fees.

The server takes, as input, the array of simulated internal fees and the external billing amount. The server compares each simulated internal fee to the external billing amount by computing a savings value equal to the external billing amount minus the simulated internal fee, and stores the savings values in a separate array.

The server locates, by a minimum or maximum operation on the simulated fees or the savings values, the index of the rate structure that yields the most favorable fee for the user, such as the lowest internal fee or highest savings.

The server outputs a selection result containing the identifier of the most economical rate structure, its simulated fee, and the corresponding savings amount, and retains this selection result in memory for use in document generation and prompt construction.

Step 7:

The server prepares structured result data for document generation.

The server takes, as input, the selection result, the full set of simulated internal fees, the savings values, and the stored external charge information.

The server constructs a structured object that includes a summary of the external charge (billing amount and usage conditions), a list of all internal rate structures with their simulated fees and savings, and a record of the most economical rate structure flagged as recommended. The server formats numeric values, for example rounding to whole currency units, and attaches labels such as plan names and explanatory headings.

The server outputs this structured result object as a document configuration input that will control the content and layout of the proposal document.

Step 8:

The server constructs a prompt sentence for a generative AI model based on the structured result data.

The server takes, as input, the external billing amount, the usage conditions, the simulated fees for at least one or more internal rate structures, and the identity of the recommended rate structure.

The server embeds these values into a natural language template, producing a prompt sentence such as:

“If a customer is currently paying 10,000 yen per month to another company for mobile service, and our Plan A costs 8,000 yen per month while our Plan B costs 9,000 yen per month under the same usage conditions, please explain which of our plans is the most economical option and describe, in clear and polite language, how much the customer can save and why the recommended plan is advantageous.”

The server may adjust the prompt sentence according to system settings, such as language or required detail level, and outputs the final prompt sentence as a textual input to the generative AI model.

Step 9:

The server invokes the generative AI model with the constructed prompt sentence and receives explanatory text.

The server takes, as input, the prompt sentence and any control parameters for the generative AI model, such as a maximum output length or a style indicator.

The server encodes the prompt sentence into tokens, supplies the tokens to the generative AI model, and causes the model to execute its internal inference procedure to compute probability distributions over output tokens and generate a sequence of text tokens as a candidate explanation.

The server decodes the generated tokens into human-readable text and performs post-processing, such as trimming incomplete sentences or checking for the presence of required elements like an explicit savings amount.

The server outputs a finalized explanatory text and recommendation content that is consistent with the numerical results and suitable for insertion into the proposal document.

Step 10:

The server generates a proposal document in an electronic format using the document configuration input and the explanatory text.

The server takes, as input, the structured result object containing document configuration information and the explanatory text produced by the generative AI model.

The server initializes the electronic document generation program group, defines page size, margins, font styles, and section structures, and then places content elements on pages according to the configuration.

The server draws tables showing each internal rate structure, its simulated fee, and the savings compared with the external charge, and highlights the recommended rate structure. The server inserts the explanatory text and recommendation content into designated sections as paragraphs, and embeds metadata such as generation date and user identifier.

The server outputs a binary representation of the proposal document, for example a portable document format file stored in memory as a byte stream.

Step 11:

The server transmits the generated proposal document to the terminal.

The server takes, as input, the binary representation of the proposal document and a destination address associated with the terminal that initiated the request.

The server constructs an HTTP response message with appropriate headers indicating the content type and file name, places the document byte stream in the response body, and sends the response via the network interface.

The server outputs the response onto the communication network, enabling the terminal to receive the proposal document.

Step 12:

The terminal receives and presents the proposal document to the user.

The terminal takes, as input, the HTTP response from the server and extracts the proposal document byte stream from the response body.

The terminal stores the document in a temporary file or in memory, and invokes a viewer component, such as a built-in document renderer, to interpret the document format.

The terminal renders the document pages on the display, including the comparison tables, highlighted recommended rate structure, and explanatory text generated by the generative AI model.

The terminal outputs a visual representation of the proposal document to the user, allowing the user to read the recommendation, understand the savings, and decide whether to proceed with a plan change or further inquiry.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional computer-implemented plan recommendation systems for electronic payment services typically perform static rule-based comparisons between a user's current billing information and a fixed set of tariff plans. Such systems suffer from multiple technical limitations. First, they often process billing information as loosely structured or semi-structured data, which leads to inefficient validation and error-prone downstream computation, thereby increasing processing overhead and reducing reliability of cost simulations executed by the processor. Second, existing systems commonly separate cost simulation logic from natural language generation logic, resulting in duplicated data transformations, inconsistent proposal content, and increased latency due to redundant processing pipelines and repeated access to storage resources. Third, when integrating generative AI models, many implementations simply pass ad hoc text prompts without a formally defined intermediate representation, which causes unstable model behavior, difficulties in controlling generated output, and inefficient use of computational resources on both the server and the model side. Fourth, current systems provide limited support for automated handling of conditional discounts that require internal approval workflows, thereby forcing manual preparation of approval requests and introducing additional latency, inconsistencies, and opportunities for human error in enterprise environments. Fifth, conventional systems generally fail to adapt proposal content and prompt sentences to dynamically inferred user states, resulting in generic user interfaces that can increase the number of user interactions required to reach a decision and reduce overall system efficiency from a human-computer interaction perspective.

Accordingly, there is a need for a computer-implemented technique that improves the way a processor acquires, validates, structures, and reuses billing and plan information in memory and storage, that tightly integrates tariff simulation with controlled natural language generation, and that systematically leverages a generative AI model via prompt sentences derived from structured proposal data. There is also a need for a system that programmatically generates and manages discount approval requests as part of a unified data flow, and that dynamically adjusts proposal expressions and presentation levels based on user state information inferred from operation history and response text. By addressing these issues at the level of data structures, processing sequences, and model interaction protocols executed by a processor, the present invention aims to improve the technical field of computer-based plan recommendation and document generation systems.

The specific processing by the specific processing unit 290 of the data processing device 12 in Application Example 1 is realized by the following means.

The present invention provides a server comprising a processor configured to acquire billing information related to a plurality of electronic payment services used by a user, store the billing information as structured data in a storage device, verify validity of the billing information, obtain the billing information and a plurality of in-house tariff plan information stored in the storage device, normalize a usage pattern based on the billing information for each item of the in-house tariff plan information, perform fee simulation for each item of the in-house tariff plan information, select a most economical tariff plan from among the plurality of in-house tariff plan information, calculate comparison information including a usage status of an external service, generate proposal structured data including proposal content based on the selected tariff plan and the comparison information, generate a skeletal proposal text in natural language by performing template processing or rule-based processing using the proposal structured data, generate a generation input sentence including situation description information based on the proposal structured data and the skeletal proposal text, generate a prompt sentence for inputting the generation input sentence into a generative AI model, acquire natural language text output from the generative AI model to supplement or revise content of a proposal document, transmit the proposal document and a user-oriented prompt sentence generated by the generative AI model to a terminal device, record a selection result based on selection information received from the terminal device, optionally generate and transmit discount approval request data to an internal business processing system when a relative discount condition associated with the selected tariff plan is potentially applicable, and optionally estimate user state information from operation history information or response text information received from the terminal device and add the user state information to the situation description information so as to dynamically adjust the proposal document and the user-oriented prompt sentence. This enables improved computer operation by enforcing structured acquisition and validation of billing data, reducing redundant data transformations between simulation and language generation, stabilizing and controlling generative AI model behavior through structured prompt sentences derived from proposal structured data, automating discount approval workflows within a unified processing pipeline, and adapting system-generated proposal outputs to inferred user states, thereby enhancing processing efficiency, consistency of generated documents, and responsiveness of the overall server-terminal interaction.

The term “processor” refers to a hardware-implemented data processing unit, such as a central processing unit or other execution circuitry, that executes instructions to perform arithmetic, logical, control, and input/output operations required to implement the functions described in the present disclosure.

The term “billing information” refers to data representing monetary charges and related usage conditions associated with one or more services used by a user, including, for example, service identifiers, billed amounts, billing periods, and usage frequency indicators.

The term “electronic payment service” refers to a transaction processing service provided over a communication network that allows a user to perform payments, transfers, or settlements electronically, and for which periodic or per-transaction billing information is generated.

The term “structured data” refers to data organized according to a predefined schema or format, such as records with named fields or entries in a table, that enables deterministic parsing, validation, and computational processing by the processor.

The term “storage device” refers to a hardware or virtualized component, such as a memory device or non-volatile storage system, configured to store data including billing information, tariff plan information, proposal structured data, and execution logs for access by the processor.

The term “in-house tariff plan information” refers to data representing a plurality of charging schemes provided by an entity operating the system, including, for example, identifiers, base fees, variable pricing parameters, discount conditions, and applicability constraints.

The term “usage pattern” refers to a representation of how a user utilizes one or more services over a given period, including metrics such as transaction counts, transaction amounts, frequency categories, and other derived statistics computed from billing information.

The term “normalize” refers to processing data to convert it into a standard or comparable representation, such as scaling, categorizing, or otherwise transforming usage pattern data so that different tariff plans can be evaluated using a common computational basis.

The term “fee simulation” refers to a computational procedure by which the processor calculates estimated fees for each tariff plan using normalized usage pattern data and plan parameters in order to predict expected costs under different tariff plans.

The term “most economical tariff plan” refers to at least one tariff plan selected by the processor from a plurality of tariff plans based on a comparison of simulated fees, such that the plan minimizes a predetermined cost metric or satisfies a defined cost-optimization criterion.

The term “comparison information” refers to data computed by the processor that quantifies differences between simulated fees for in-house tariff plans and charges associated with external services, including, for example, cost differences and relative savings measures.

The term “proposal structured data” refers to an intermediate data representation constructed by the processor that encodes selected tariff plan information, comparison information, and additional metadata in a machine-readable format for subsequent generation of natural language text.

The term “skeletal proposal text” refers to a preliminary natural language text generated by the processor from proposal structured data using template processing or rule-based processing, which defines the basic structure and main contents of a proposal document before refinement.

The term “template processing” refers to a technique in which the processor fills predetermined text templates with variable values extracted from proposal structured data in order to generate natural language sentences or document segments.

The term “rule-based processing” refers to a procedure in which the processor applies predefined logical rules or conditional expressions to proposal structured data to determine how text elements are combined, ordered, or phrased in generating natural language output.

The term “generation input sentence” refers to a machine-readable input string constructed by the processor that includes situation description information and other context, which is intended to be provided to a generative AI model to request generation of natural language text.

The term “situation description information” refers to textual or symbolic information generated by the processor that summarizes relevant circumstances, such as the user's current billing status, selected tariff plan, and comparison results, for use as context when generating natural language text.

The term “prompt sentence” refers to a text sequence generated by the processor that guides or conditions a generative AI model or a user, including instructions or questions specifying how the generative AI model should generate text or what information the user should provide.

The term “generative AI model” refers to a machine learning model configured to generate natural language text based on one or more input sequences, such as prompts or context strings, and implemented using, for example, neural network architectures trained on textual data.

The term “proposal document” refers to a natural language document generated at least in part by the processor that describes one or more recommended tariff plans, associated costs, and comparative benefits for presentation to a user.

The term “terminal device” refers to a user-operated computing device, such as a mobile terminal, tablet device, or personal computer, configured to exchange data with the server system, display proposal documents and prompt sentences, and transmit user selections or responses.

The term “selection information” refers to data transmitted from the terminal device to the processor that indicates a user's choice or response with respect to at least one recommended tariff plan or proposed action, such as acceptance, rejection, or request for additional details.

The term “relative discount condition” refers to a pricing condition under which a discount applicable to a tariff plan depends on a relationship with other usage metrics or billing contexts, such as total usage across services or comparison against baseline values.

The term “discount approval request data” refers to structured data generated by the processor that specifies details of a proposed discount application, including plan identifiers, discount conditions, computed amounts, and contextual justification, for use in an approval workflow.

The term “internal business processing system” refers to an information processing system operated within an organization that manages business workflows, including approval procedures for discounts, and that is communicatively coupled to the processor.

The term “approval procedure” refers to an automated or semi-automated workflow executed by an internal business processing system to evaluate, accept, or reject a discount approval request based on predefined rules or human review.

The term “approval state” refers to status information indicating a current stage or result of an approval procedure for a discount, such as pending, approved, rejected, or canceled, which is managed by the processor and/or the internal business processing system.

The term “user state information” refers to information estimated by the processor that represents a state of a user, including, for example, inferred understanding level, engagement level, or hesitancy, based on analysis of operation history information or response text information.

The term “operation history information” refers to data representing interaction events performed by a user on the terminal device, such as button presses, screen transitions, dwell times, or input sequences, collected for analysis by the processor.

The term “response text information” refers to textual input provided by a user via the terminal device, including free-form comments, answers to questions, or other user-entered text used by the processor to infer user state information.

The term “expression content” refers to specific wording, tone, level of detail, and structure of natural language text included in a proposal document or a user-oriented prompt sentence generated by or via the processor.

The term “presentation level” refers to a degree of detail or complexity with which information is displayed or conveyed to a user, such as a simplified summary level, an intermediate explanation level, or a detailed technical level, as controlled by the processor.

The term “user-oriented prompt sentence” refers to a natural language sentence generated by or via the processor and intended for display on a terminal device to guide a user's actions, such as prompting the user to provide information, review a proposal, or make a selection.

In one embodiment, a server, a terminal, and a user cooperate to implement the invention. The server includes at least one processor, a main memory, a non-volatile storage device, and a network interface. The terminal includes a processor, a display, an input interface, a memory, and a communication interface. The user operates the terminal to provide billing information, review proposal documents, and select tariff plans.

The server executes an operating system such as a general-purpose server operating system and runs an application server environment implementing backend logic. The server stores billing information, in-house tariff plan information, proposal structured data, and log data in a database system such as a relational database. The server uses a data access layer to read and write records in tables representing tariff plans, simulations, user decisions, and approval requests.

The server uses main memory to hold intermediate computation structures, including normalized usage patterns, cost simulation results, and context objects for natural language generation. The server represents billing information as structured records containing fields such as a service identifier, a billed amount, a billing period, and a usage frequency category. The server represents tariff plan information as structured records containing fields such as a plan identifier, a base fee, one or more variable fee coefficients, discount threshold values, and flags indicating relative discount conditions.

The terminal executes an application, such as a mobile application, that presents user interfaces for billing information input, proposal review, and decision confirmation. The terminal stores temporary user input in local memory as structured objects with fields corresponding to billing records. The terminal transmits such structured objects to the server via a communication protocol such as HTTPS, using request/response messages encoded in a structured textual format.

The server validates billing information by performing range checks, type checks, and integrity checks on the structured data. The server discards malformed records and returns error responses when critical fields are missing or inconsistent. The server converts categorical usage frequency values into numerical factors by mapping categories such as “low,” “normal,” and “high” to predetermined multipliers. The server aggregates billing records for a given user to compute normalized usage patterns, including total monthly amount, average transaction size, estimated transaction count, and variability measures. The server performs fee simulation by applying plan-specific formulas to the normalized usage patterns. The server reads parameters from tariff plan records, such as base fee values, per-transaction fee rates, percentage-based fees, and discount thresholds. The server computes estimated monthly cost for each plan by combining base and variable fees and applying conditional discount rules encoded as logical expressions. In some embodiments, the server evaluates piecewise functions to model tiered pricing structures; in other embodiments, the server uses polynomial or piecewise-linear approximations to represent more complex pricing schedules.

The server selects a most economical tariff plan by comparing estimated monthly costs across multiple plans. The server calculates comparison information such as absolute savings and relative savings ratio compared to one or more external services represented in the billing information. The server stores simulation results and comparison information in a simulation result table to support traceability and later analysis.

The server constructs proposal structured data that encapsulates at least the selected tariff plan identifier, the estimated costs for multiple plans, the current external cost, the computed savings, and metadata such as simulation timestamp and user segment. The server uses a template-based generation module to convert the proposal structured data into skeletal proposal text. The server maintains templates containing fixed sentences and placeholders; the server fills these placeholders with values from the proposal structured data. The server also uses rule-based transformations to adjust sentence order, include or exclude optional sections, or change wording depending on conditions such as savings magnitude or presence of special discounts.

The server generates a generation input sentence that combines situation description information with the skeletal proposal text. The server produces the generation input sentence as a textual sequence containing a description of the user's current billing situation, summarized simulation results, and instructions to refine or expand the explanation. The server then generates a prompt sentence that specifies how a generative AI model should process the generation input sentence. For example, the server generates a prompt sentence such as:

“You are an assistant that explains electronic payment plans in clear and concise language. Based on the following context, generate a short explanation for the user and a question asking whether the user wants to switch to the recommended plan.”

The server concatenates the prompt sentence with the generation input sentence and supplies the combined sequence to a generative AI model.

In one embodiment, the server uses a generative AI model implemented as a transformer-based neural network. The server loads the model parameters into a model-serving environment running on computing hardware including one or more graphics processing units or other accelerators. The neural network includes an embedding layer for token representation, multiple self-attention layers organized into a stack of transformer blocks, feedforward sublayers with non-linear activation functions, layer normalization components, and a final linear projection layer that outputs token logits. The server configures the model with a specific number of attention heads, hidden dimension size, and number of layers to achieve a trade-off between generation quality and response latency.

The server tokenizes the prompt sentence and the generation input sentence into discrete tokens using a subword tokenization scheme. The server feeds a sequence of token embeddings into the transformer network and obtains output token probabilities step by step. The server selects output tokens using a decoding algorithm such as greedy decoding or top-k sampling with a predetermined temperature parameter. The server reconstructs natural language text from the output tokens and obtains generated explanation content and user-oriented prompt phrases.

The server uses a loss function such as cross-entropy loss for model training and updates network parameters using an optimization algorithm such as stochastic gradient descent with adaptive moment estimation. The server trains the generative AI model on a corpus that includes examples of plan explanations, comparative statements, and user guidance questions. The server optionally performs fine-tuning using domain-specific data where input sequences consist of structured context descriptions and target sequences consist of high-quality proposal explanations. The server stores model checkpoints in a storage device and loads a selected checkpoint into the serving environment when performing inference.

The server processes user state information by analyzing operation history information and response text information received from the terminal. The server stores operation events, such as time taken to read a proposal, number of times a user expands detail sections, and number of times a user requests recalculation, as structured log entries. The server extracts features such as dwell time distributions, repetition patterns, and navigation paths. The server also processes response text information using natural language analysis techniques such as tokenization, part-of-speech tagging, and sentiment scoring. The server uses these features as inputs to a classification algorithm, which may be a separate neural network or a rule-based classifier, to estimate user states such as “confident,” “uncertain,” or “requires more detail.”

The server incorporates the estimated user state information into the situation description information embedded in the generation input sentence. For example, when the user state indicates high uncertainty, the server appends a description requiring the generative AI model to produce more detailed and reassuring explanations. In that case, the server may generate an additional instruction such as:

“The user seems uncertain and has requested details multiple times. Please provide a more detailed explanation in simple terms, and then ask the user whether they want to proceed.”

The server, by structuring data and generating prompts in this controlled manner, reduces variability in the generative AI model output and improves consistency across responses, thereby improving the technical behavior of the model-serving subsystem.

The server also interacts with an internal business processing system when a relative discount condition is potentially applicable. The server analyzes tariff plan rules to determine whether discounts depend on external factors such as aggregate monthly volume or multi-service usage. When such conditions are present, the server automatically generates discount approval request data that includes a plan identifier, a discount request amount, justification fields derived from comparison information, and any required customer segment attributes. The server transmits this approval request data over a secure communication channel to the internal system, which operates an approval workflow. The server receives approval state updates and records them in association with the corresponding proposal structured data. In some embodiments, the server reduces communication overhead and improves overall processing latency by caching tariff plan information and precomputed simulation parameters in main memory. The server further reduces redundant computations by storing normalized usage patterns and reusing them across multiple simulations when the user adjusts secondary parameters without changing fundamental billing data. This approach improves computational efficiency by eliminating repeated parsing and normalization steps.

The terminal, in some embodiments, performs local validation and formatting of billing information before transmitting it to the server. The terminal checks numeric formats, required fields, and basic consistency rules. By performing such pre-processing, the terminal reduces the rate of invalid requests reaching the server, thereby lowering server-side validation loads and network retransmissions. The terminal displays proposal documents and user-oriented prompt sentences received from the server on a graphical user interface. The terminal organizes information in different presentation levels, such as a summary view and a detailed breakdown view, according to data supplied by the server.

The user enters billing information into input fields on the terminal, including service names, billed amounts, and usage frequencies. The user reviews recommended tariff plans and associated savings on the terminal display. The user then selects an action, such as accepting a recommended plan or requesting additional information. The terminal transmits the user's selection information back to the server, which records the selection in the storage device. The server, by using structured data representations, normalization modules, deterministic fee simulation algorithms, and a generative AI model that is tightly integrated through context-aware prompt sentences, improves computer technology in several ways. The server reduces total processing time compared to naive implementations by avoiding redundant parsing and recomputation of intermediate representations. The server increases accuracy of cost simulations by explicitly encoding tariff plan rules and normalization steps as data-processing operations executed by the processor. The server improves data management by enforcing schema-based storage and by linking simulation, approval, and decision records through unique identifiers. The server reduces communication load by optimizing payload sizes and by using cached and incremental updates when only partial information changes.

The server also improves the technical behavior of the generative AI model subsystem. The server constructs prompts and context sentences systematically from structured proposal data rather than manually authored free-form text. This controlled prompt construction reduces the search space of possible outputs and leads to more stable and predictable generation, thereby reducing the need for post-processing and repeated queries. As a result, the generative AI model consumes fewer computational resources per useful response, which is a technical improvement within the model-serving system.

The server uses non-conventional rules and sequences that differ from merely automating human decision processes. The server encodes tariff rules, normalization mappings, and classification thresholds as machine-level rules optimized for computational evaluation rather than for human readability. The server uses machine-learned models to infer user states based on high-dimensional feature vectors derived from operation logs and response texts, a process that is not feasibly performed in real time by human agents. These technical mechanisms yield improved response times, higher consistency, and reduced error rates, demonstrating that the system goes beyond simple business workflow automation.

In alternative embodiments, the server may use different types of databases, such as key-value stores or columnar data stores, while still maintaining structured representations for billing information, tariff plan information, and proposal structured data. The server may deploy the generative AI model in different environments, such as on-premises model servers or remote inference services, while using the same controlled prompt construction approach. The server may store different sets of user features for state estimation, such as device type, network latency patterns, or historical decision patterns, and may change classification algorithms, for example, from a rule-based classifier to a gradient-boosted decision tree model.

In another embodiment, the terminal may be a desktop computer or a specialized kiosk device rather than a mobile terminal, while still exchanging the same categories of structured data with the server. The user may access the system through a web browser, and the terminal may execute client-side code to manage display layouts and interaction logic. The overall architecture, where the server performs the main computations and the terminal primarily handles user interaction, remains unchanged.

Thus, the server, terminal, and user cooperate to implement a system that is not merely a generic data acquisition and display mechanism but a technically configured platform where structured data handling, algorithmic normalization, optimized fee simulation, and controlled generative AI model integration combine to improve computing efficiency, accuracy, and stability in the context of plan recommendation and natural language proposal generation.

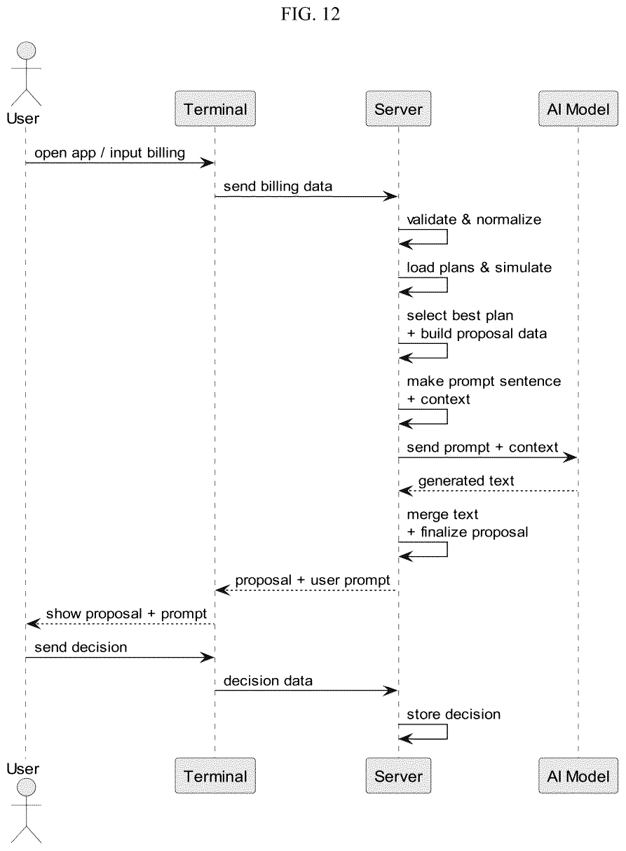

The following describes the processing flow using FIG. 12.

Step 1:

User operates the terminal to start the application and open a billing input screen.

Terminal displays input fields for service name, billed amount, billing period, and usage frequency category.

Input: No prior data; only the user's interaction events.

Output: An empty billing information form presented on the terminal display.

Terminal prepares in-memory data structures (for example, an array of billing record objects with fields for service identifier, amount, and frequency) to hold subsequent user input.

Step 2:

User enters billing information for multiple electronic payment services into the terminal.

Terminal captures the entered values and stores them in the prepared billing record objects.

Input: User keystrokes, touch inputs, and selected items on the billing form.

Output: A set of populated billing record objects held in the terminal's memory.

Terminal performs local validation by checking data types (for example, numeric values for amounts), required fields, and basic range limits; terminal flags invalid fields and displays error messages, thereby preventing malformed records from proceeding.

Step 3:

User confirms that the entered billing information is correct and triggers submission.

Terminal converts the in-memory billing record objects into a structured payload.

Input: Validated billing record objects.

Output: A structured request payload containing an array of billing entries, prepared for transmission.

Terminal formats the payload in a textual representation, attaches metadata such as a user identifier and timestamp, and prepares an HTTPS request addressed to the server.

Step 4:

Terminal transmits the structured billing payload to the server.

Terminal uses a communication library to send the HTTPS request and waits for a response.

Input: Structured request payload and server endpoint information.

Output: A network message transmitted to the server and a pending state awaiting the server's reply.

Terminal displays a progress indicator while the request is in flight and records a correlation identifier to match the eventual response with the originating request.

Step 5:

Server receives the HTTPS request and extracts the billing payload.

Server parses the textual representation into internal structured records corresponding to billing entries.

Input: Structured request payload received from the terminal.

Output: Validated internal billing records stored in server memory; or, in case of error, an error response.

Server performs schema validation, data type checks, and value range checks; server discards or flags malformed entries, logs the event, and, if critical errors are found, constructs and returns an error response to the terminal.

Step 6:

Server retrieves in-house tariff plan information from a storage device.

Server issues queries to a database to load active tariff plans applicable to the user.

Input: User identifier and plan selection criteria (for example, region, account type).

Output: A set of tariff plan records containing fields such as plan identifiers, base fees, variable fee parameters, and discount rules.

Server converts raw database rows into in-memory plan objects and may cache them for reuse, reducing future database accesses and improving response time.

Step 7:

Server normalizes the user's billing information into usage patterns.

Server aggregates amounts, estimates transaction counts, and converts usage frequency categories into numerical factors.

Input: Validated billing records and normalization parameters (for example, mapping tables for frequency categories).

Output: One or more normalized usage pattern objects representing metrics such as total monthly volume and typical usage intensity.

Server applies arithmetic operations (sums, averages, multiplications) and mapping functions, thereby transforming heterogeneous user input into a standardized representation that can be used across multiple tariff plans.

Step 8:

Server performs fee simulations for each in-house tariff plan using the normalized usage patterns.

Server applies plan-specific formulas encoded in the plan records to compute estimated costs.

Input: Tariff plan objects and normalized usage pattern objects.

Output: A set of simulation result records, each containing a plan identifier and an estimated monthly fee.

Server combines base fee and variable fee components using arithmetic operations, evaluates conditional discount expressions, and computes intermediate values such as discounted amounts or tier thresholds to derive final estimated fees.

Step 9:

Server selects one or more most economical tariff plans based on the simulation results.

Server compares estimated fees and determines which plan minimizes a defined cost metric.

Input: Simulation result records and decision rules for selecting a preferred plan.

Output: A selected plan identifier (or a set of candidate identifiers) and computed comparison information such as savings amounts.

Server calculates absolute differences and relative ratios between the external cost derived from billing records and each in-house plan cost, and then attaches these comparison metrics to the selection result.

Step 10:

Server constructs proposal structured data from the selected plan and the comparison information.

Server creates a data object that encapsulates recommended plan details, estimated costs, savings, and relevant metadata.

Input: Selected plan identifier, simulation results, and comparison information.

Output: Proposal structured data stored in server memory as a structured object or record.

Server adds fields such as explanation flags (for example, whether to emphasize savings) and discount-related indicators to this proposal structured data to guide subsequent text generation.

Step 11:

Server generates skeletal proposal text using template processing and rule-based logic.

Server selects appropriate text templates and fills placeholders with values from the proposal structured data.

Input: Proposal structured data and a library of templates and rules.

Output: A skeletal proposal text string describing at least the recommended plan and cost differences.

Server applies rule-based conditions, such as including detailed breakdowns only if savings exceed a threshold, and reorders sentence segments based on plan characteristics, thereby producing a coherent but still preliminary text.

Step 12:

Server estimates user state information, when available, from past operation history and response text.

Server analyzes logs of user interactions and any textual responses to characterize user behavior.

Input: Operation history records, response text strings, and feature extraction parameters.

Output: A user state label or vector (for example, indicating uncertainty level or desired detail level).

Server computes numerical features such as dwell times, click counts, and sentiment scores, and feeds them into a classifier; server then writes the resulting user state into memory for use in later processing.

Step 13:

Server generates situation description information for use with a generative AI model.

Server summarizes billing context, simulation outcomes, selected plan, and optionally user state into a textual description.

Input: Proposal structured data, user state information (if available), and configuration rules for context construction.

Output: A situation description text capturing the essential facts needed to generate an explanation.

Server concatenates descriptive fragments, ensures that identifiers and amounts are converted into human-readable form, and enforces a consistent ordering of elements to stabilize downstream generation behavior.

Step 14:

Server generates a generation input sentence and a prompt sentence for the generative AI model.

Server combines the situation description information with instructions to guide the model's output.

Input: Situation description text and internal guidelines for desired explanation style.

Output: A generation input sentence and a prompt sentence ready to be consumed by the generative AI model.

Server, for example, creates a prompt sentence such as:

“You are an assistant that explains electronic payment plans in clear and concise language. Based on the following context, generate a short explanation for the user and a question asking whether the user wants to switch to the recommended plan.”

Server then appends the situation description text to this prompt sentence to form a single input sequence for the model.

Step 15:

Server invokes the generative AI model with the constructed input sequence.

Server tokenizes the combined prompt sentence and situation description, feeds token embeddings into the model, and decodes output tokens.

Input: Combined input sequence representing the prompt sentence and the situation description.

Output: Generated natural language text including an enhanced proposal explanation and user-oriented phrases.

Server uses a decoding algorithm (for example, greedy or top-k sampling) to transform model output probabilities into actual tokens, reconstructs text from tokens, and separates the explanatory portion from the user-directed question or guidance segment.

Step 16:

Server merges the skeletal proposal text and the model-generated text into a final proposal document.

Server aligns key information and resolves any inconsistencies between deterministic content and generated content.

Input: Skeletal proposal text and the generated natural language text from the generative AI model.

Output: A finalized proposal document string that integrates structured and generated components.

Server performs consistency checks (for example, verifying that numerical values and plan names match the simulation results) and edits or discards conflicting model-generated fragments, thereby ensuring accuracy while still benefiting from fluent natural language.

Step 17:

Server generates a user-oriented prompt sentence from the model output or from an auxiliary template.

Server identifies the segment in the generated text that corresponds to a direct question or instruction for the user.

Input: Model-generated text and, optionally, template-based fallback phrases.

Output: A user-oriented prompt sentence suitable for display on the terminal.

Server extracts or constructs sentences such as:

“Please review Plan A, which can reduce your monthly cost compared with your current service. Would you like to switch to this plan now?”

Server ensures that the prompt sentence is concise and refers to the correct plan identifier and savings values.

Step 18:

Server packages the proposal document and user-oriented prompt sentence into a response payload.

Server includes additional metadata such as selected plan identifiers, simulation identifiers, and approval status flags.

Input: Final proposal document, user-oriented prompt sentence, and internal identifiers.

Output: A structured response payload ready for transmission to the terminal.

Server serializes this payload into a textual representation and associates it with a response identifier that matches the request correlation maintained by the terminal.

Step 19:

Server transmits the response payload to the terminal over the network.

Server sends an HTTPS response with the serialized payload and an appropriate status code.

Input: Response payload and network connection state.

Output: A network message delivered to the terminal containing the proposal and prompt sentence.

Server logs the transmission event and stores a record linking the simulation, the generated texts, and the response time for monitoring and analysis.

Step 20:

Terminal receives the response payload and reconstructs the proposal document and prompt sentence.

Terminal parses the textual representation into internal data structures for display.

Input: Response payload received over the network.

Output: In-memory objects representing the final proposal document, recommended plan details, and the user-oriented prompt sentence.

Terminal validates the integrity of the payload (for example, via checksum or schema checks) and prepares UI components to show the received content.

Step 21:

Terminal displays the proposal document and the user-oriented prompt sentence to the user.

Terminal organizes the proposal text into sections, such as a summary view and a detailed breakdown view, and highlights the prompt sentence.

Input: Proposal document object and prompt sentence object.

Output: Visual elements rendered on the display, including text, layout, and interactive controls.

Terminal places interactive buttons (for example, “Accept plan”, “View details”, “Recalculate”) near the prompt sentence to guide the user's next action.

Step 22:

User reviews the displayed proposal document and responds to the prompt sentence.

User reads the explanation, compares costs, and selects an appropriate action through the terminal interface.

Input: Visual information rendered on the terminal and the user's understanding and preferences.

Output: A user decision captured as an interaction event (for example, a button press or a text input).

User may, for instance, tap a button agreeing to switch to the recommended plan or type a question requesting further clarification.

Step 23:

Terminal converts the user's decision into structured selection information and sends it to the server.

Terminal creates a payload containing the selected plan identifier, decision type, and reference to the related simulation.

Input: User interaction events indicating a choice or request.

Output: A structured decision payload transmitted to the server over HTTPS.

Terminal may also attach contextual information, such as the current view and time spent on the proposal, to support further analysis by the server.

Step 24:

Server receives the selection information and records the decision in persistent storage.

Server updates decision tables and links the decision record to the original simulation and proposal structured data.

Input: Decision payload from the terminal.

Output: A stored decision record and possibly updated approval or activation status entries.

Server performs consistency checks (for example, verifying that the referenced simulation exists and has not expired), writes the decision record to the storage device, and triggers any necessary follow-up processes, such as initiating account changes or launching discount approval workflows.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented pricing and proposal systems suffer from several technical limitations in how they process unstructured commercial documents and external pricing data. In typical systems, proposal documents are created and analyzed manually or with simple template-based tools, and external offering information from other organizations is stored as isolated data that is not coherently linked to proposal content. As a result, processor resources are used inefficiently: natural language content in proposal documents is not normalized into structured data in a consistent machine-readable form, pricing comparisons are performed by ad hoc scripts or by human operators, and any required approval workflows are triggered by manual input rather than by deterministic logic executed by a processor.

In such systems, when a user submits a proposal document including complex textual descriptions, tables, and conditional pricing rules, the system generally treats the document as a file object without performing comprehensive natural language parsing and semantic structuring. The processor typically cannot automatically identify and normalize key pricing attributes such as base price, discount rate, discount period, and discount reason across heterogeneous document formats. This leads to repeated parsing routines, redundant database queries, and non-optimized data access patterns, which in turn increase processing latency and reduce overall throughput of the computing environment.

Further, although generative AI models have become available as external services, conventional integrations call such models in a generic manner, often passing long raw text segments in a single prompt without aligning the model's operation with internally maintained structured data and pricing rules. The lack of a dedicated prompt generation mechanism that fuses structured pricing data, summaries of other organizations' offerings, and summaries of own organization offerings results in unstable and non-deterministic outputs. From a computer-technology perspective, this causes unnecessary network overhead, repeated or failed inference calls, and inefficient use of memory and CPU cycles on both the client and server sides.

Moreover, conventional systems do not systematically link, at the data-structure level, (i) the extracted and normalized pricing and condition information, (ii) the analysis result returned by a generative AI model, and (iii) the approval request data sent to an internal business system. Without such linkage, subsequent processing such as re-analysis, re-generation of proposals, or modification of approval requests requires re-running the entire pipeline or re-parsing original documents, leading to redundant computation and complex control logic in application code.

Additionally, when a user wishes to iteratively refine a proposal, existing systems provide only coarse-grained user interfaces that do not allow dynamic modification of prompts supplied to a generative AI model. Because prompt configuration is fixed or hard-coded, the system cannot adapt the model's behavior to changing user inputs or updated competitor data without re-deploying application components or restarting services. This static integration pattern degrades the flexibility of the computing system and prevents real-time optimization of resource usage based on the latest business context.

Accordingly, there is a need for an improved computer-implemented system and method that (i) automatically acquires and structures information relating to offerings provided by other organizations and offerings provided by an own organization, (ii) transforms proposal document data into structured pricing and condition data using natural language processing executed by a processor, (iii) generates, in the processor, prompt sentences that coherently combine structured data and summaries of offerings for input to a generative AI model, (iv) automatically generates or supplements proposal documents and approval request data based on analysis results, and (v) maintains explicit data associations among proposal documents, analysis results, and approval request data. Such a system should improve the efficiency, determinism, and scalability of the underlying computer processing, reduce redundant parsing and inference calls, and enable dynamic, user-driven re-analysis with controlled modification of prompt sentences.

The specific processing by the specific processing unit 290 of the data processing device 12 in Example 2 is realized by the following means.

The present invention provides a server comprising a processor and a storage device, the processor being configured to execute instructions that cause the server to acquire and store, in the storage device, information relating to offerings provided by other organizations and information relating to offerings provided by an own organization, compare the information relating to offerings provided by the other organizations with the information relating to offerings provided by the own organization to calculate candidate pricing schemes, receive data of a proposal document from a user terminal, extract character information and numerical information from the proposal document, and identify, as structured data, price information, condition information, and discount information in the proposal document by using natural language processing technology, determine, based on the structured data and the information relating to offerings provided by the other organizations and the information relating to offerings provided by the own organization, whether a relative adjustment of a pricing scheme is required, generate a prompt sentence to be input to a generative AI model for analysis target data including the structured data, the information relating to offerings provided by the other organizations, and the information relating to offerings provided by the own organization, transmit the prompt sentence and the analysis target data to the generative AI model via a communication interface, obtain, from the generative AI model, an analysis result relating to contents of the proposal document and the pricing scheme, automatically generate or supplement a proposal document including an optimal pricing scheme on the basis of the analysis result and a determination result of whether the relative adjustment of the pricing scheme is required, automatically generate approval request data including a discount rate, a discount reason, and a discount period when it is determined, on the basis of the analysis result and the determination result, that the relative adjustment of the pricing scheme is required, transmit the approval request data to an internal business system, and record the proposal document, the analysis result, and the approval request data in association with one another in the storage device and provide information based on the proposal document, the analysis result, and the approval request data to the user terminal. This enables the server to transform heterogeneous, unstructured proposal and offering data into normalized structured data, to invoke a generative AI model through precisely constructed prompt sentences that combine internal and external pricing information, and to automatically generate optimized proposal documents and approval workflows while reducing redundant parsing operations, improving determinism and efficiency of model interactions, and enhancing overall performance and scalability of the computer system.

The term “processor” refers to a hardware execution unit or a plurality of such units configured to execute instructions, including but not limited to a central processing unit, a graphics processing unit, or any other programmable computation device.

The term “storage device” refers to any non-transitory computer-readable medium configured to store data and instructions, including but not limited to a semiconductor memory, a magnetic storage medium, or an optical storage medium.

The term “information relating to offerings provided by other organizations” refers to data representing products or services supplied by entities other than an own organization, including attributes such as item descriptions, feature sets, unit prices, discount conditions, contractual terms, and other associated commercial parameters.

The term “information relating to offerings provided by an own organization” refers to data representing products or services supplied by the organization operating the system, including attributes such as product identifiers, standard prices, standard discount ranges, contractual terms, and internal policy constraints.

The term “candidate pricing schemes” refers to one or more pricing configurations calculated by the processor, each pricing configuration including at least a price or discount structure that is potentially applicable to a proposal for a product or service.

The term “proposal document” refers to electronic document data that describes products or services, prices, conditions, discounts, and other commercial terms to be proposed to a customer, the document being represented in a computer-readable format.

The term “character information” refers to textual data contained in a proposal document, including letters, symbols, words, and sentences that are machine-readable after parsing or optical character recognition.

The term “numerical information” refers to numeric values contained in a proposal document, including but not limited to prices, quantities, percentages, dates, and durations.

The term “structured data” refers to data normalized into a predefined schema composed of fields, records, or key-value pairs, such that elements like prices, discount rates, conditions, and durations are individually identifiable and machine-processable.

The term “price information” refers to data elements that indicate monetary amounts or price-related values, including base prices, final prices, unit prices, and other price-relevant figures.

The term “condition information” refers to data elements that indicate non-price terms associated with an offering or proposal, including but not limited to contract duration, renewal conditions, usage limitations, and special terms.

The term “discount information” refers to data elements that describe deviations from a standard price, including discount rates, discount amounts, discount reasons, discount eligibility, and discount periods.

The term “natural language processing technology” refers to algorithms and computational models that analyze or transform human language text, including techniques such as tokenization, part-of-speech tagging, entity recognition, parsing, and semantic interpretation.

The term “relative adjustment of a pricing scheme” refers to modification of a price or discount structure based at least in part on comparison with one or more reference prices or conditions, such as competitor prices, market benchmarks, or internal standard prices.

The term “prompt sentence” refers to a sequence of machine-readable text, optionally combined with structured data, that is constructed for input to a generative AI model to specify an analysis task or a generation task.

The term “generative AI model” refers to a trained machine learning model configured to generate or transform data, such as natural language text, in response to an input prompt, the model being implemented using statistical or neural network techniques.

The term “analysis target data” refers to a set of data provided to a generative AI model for analysis, the set including at least structured data extracted from a proposal document and information relating to offerings provided by other organizations and by an own organization.

The term “analysis result” refers to information output by a generative AI model or by the processor in response to analysis target data, the information including evaluations, recommendations, extracted attributes, or classifications relating to a proposal document or a pricing scheme.

The term “optimal pricing scheme” refers to a pricing configuration selected or generated on the basis of at least an analysis result and internal criteria, the configuration providing a preferred trade-off among factors such as competitiveness, profitability, and policy compliance.

The term “approval request data” refers to structured data representing a request for authorization of a pricing scheme or discount, including at least a discount rate, a discount reason, a discount period, and identifiers for the relevant offerings or customers.

The term “internal business system” refers to an information processing system operated within an organization for managing business operations, including but not limited to workflow engines, enterprise resource planning systems, or customer relationship management systems.

The term “user terminal” refers to an endpoint computing device operated by a user, including but not limited to a desktop computer, a portable computer, a tablet device, or a communication terminal, configured to send and receive data to and from the server.

In one embodiment, a server implements the claimed system as a network-accessible application running on computing hardware such as a rack-mounted computer including a multi-core central processing unit, volatile and non-volatile memory, and a network interface. The server executes an operating system such as a general-purpose server operating system and application software implemented, for example, in an object-oriented programming language. The server cooperates with a storage device that includes a relational database, a document store, and a log store implemented on magnetic or solid-state drives. A terminal, such as a personal computer, a tablet device, or a smartphone, communicates with the server via a packet-switched network using secure communication protocols. A user operates the terminal through a graphical user interface of a browser or a dedicated client application. The server executes a program composed of multiple software modules, including a data acquisition module, a document parsing module, a natural language processing module, a pricing analysis module, a generative AI integration module, an approval request generation module, and a user interface backend module. Each module reads and writes defined data structures stored in the storage device, such as normalized offering records, proposal document records, analysis result records, and approval request records.

The server acquires information relating to offerings provided by other organizations and information relating to offerings provided by an own organization into the storage device. In one example, the server receives comma-separated files or structured messages via an application programming interface from external data sources and internal business systems. The server normalizes the received data into a relational schema including tables such as OFFERING, PRICING_RULE, COMPETITOR_SUMMARY, and INTERNAL_STANDARD, with primary keys and foreign keys defined for efficient indexed access. Each record includes attributes such as product category, feature vector identifiers, base price, allowed discount range, contract duration, and competitor identifiers.

The server receives proposal document data from the terminal. The user generates a proposal document on the terminal using general-purpose office software or a web-based editor. The user then uploads the proposal document file, which may be in a formatted document format or a portable document format, through a web interface. The terminal transmits the file via a secure communication channel to the server, together with metadata such as a customer identifier and a proposal identifier. The server stores the raw file in a document store and creates a PROPOSAL record in the database including references to the stored file.

The server parses the proposal document to extract character information and numerical information. In one embodiment, the server uses a document parsing library to convert a formatted document into a plain text representation and to detect tables, paragraphs, and headings. For scanned or image-based documents, the server uses an optical character recognition engine to transform image data into textual data. The server stores intermediate representations in a TEXT_SEGMENT table, where each segment is assigned a segment identifier, a proposal identifier, an offset, and text content. For numerical information, the server uses pattern-matching routines and locale-aware parsing to detect currencies, percentages, counts, and date expressions in the text.

The server applies natural language processing technology to convert the extracted content into structured data. In one implementation, the server runs a statistical or neural sequence labeling model implemented by a natural language processing framework. The server loads, from the storage device, model parameters representing weight matrices of a deep neural network with multiple layers, for example, an embedding layer, one or more self-attention layers, and a classification head. The server maps each token in a text segment to a numeric embedding vector, performs multi-head self-attention to compute contextual representations, and applies a linear transformation and softmax function to assign labels such as PRICE_TOKEN, DISCOUNT_PERCENT, CONTRACT_DURATION, CONDITION_CLAUSE, or OTHER. The server aggregates sequences of labeled tokens into entities and writes PRICE, DISCOUNT, and CONDITION records into a STRUCTURED_PRICING table. Each record includes a proposal identifier, a field type, a numeric value where applicable, and a normalized unit.

The server calculates candidate pricing schemes by comparing structured information relating to offerings provided by the other organizations with structured information relating to offerings provided by the own organization. A pricing analysis module of the server reads competitor pricing records and internal standard pricing records for products matching the proposal, where matching may be based on product codes, vector similarity of feature descriptions, or category mappings stored in a PRODUCT_MAPPING table. The server executes arithmetic computations such as averaging competitor prices, computing relative differences, and evaluating discount margins against internal thresholds. The server writes candidate pricing schemes into a CANDIDATE_SCHEME table that includes, for each proposed line item, attributes such as a suggested price, a suggested discount, and an associated justification code.

The server determines whether a relative adjustment of a pricing scheme is required based on the structured data and the offering information. In one example, the server executes a rule engine stored in the PRICING_RULE table, which contains conditions such as “if competitor average price is more than a threshold lower than internal standard price, then mark as adjustment-required.” The processor compares calculated differences with rule thresholds and sets an adjustment flag in the CANDIDATE_SCHEME table. This deterministic logic reduces unnecessary invocation of external services and ensures that only proposals that meet defined criteria proceed to an advanced analysis stage.

The server generates a prompt sentence for a generative AI model by combining the structured data and summaries of the offering information. A generative AI integration module of the server reads from the STRUCTURED_PRICING, COMPETITOR_SUMMARY, and INTERNAL_STANDARD tables and constructs a prompt template with designated fields. The module concatenates textual segments, including a task instruction, a compressed representation of the structured pricing and conditions, and summarized competitor and own-organization offerings, to form a prompt sentence in natural language.

For example, in one embodiment, the server generates a prompt sentence such as: “You are an AI assistant specialized in pricing analysis. Analyze the following proposal data and competitor summary. Extract any missing pricing details, evaluate whether the proposed prices are competitive, and decide whether a relative price adjustment is required. If an adjustment is required, recommend a new discount rate, discount period, and discount reason consistent with the internal policy described below.”

In another example, the server generates a prompt sentence such as:

“Here is the proposal data: base price 100,000, proposed discount 10 percent, final price 90,000, new customer. Here is the competitor price range: 92,000 to 95,000 for similar products. Analyze whether the proposed pricing is competitive and whether additional relative price adjustment is needed. If adjustment is needed, propose a new discount rate, discount period, and discount reason according to the following internal policy: maximum discount 15 percent, normal range 0 to 10 percent.”

The server transmits the prompt sentence and analysis target data to a generative AI model hosted locally or as a remote service. In one implementation, the generative AI model is an auto-regressive language model implemented as a deep neural network including multiple transformer layers, each having multi-head self-attention units, feedforward units, and normalization units. The model has been trained using a supervised fine-tuning process on domain-specific text comprising proposals, pricing explanations, and approval rationales. During training, the server or an external training system minimizes a loss function such as cross-entropy between predicted token sequences and reference sequences. Weights of the model are updated via gradient-based optimization, such as stochastic gradient descent or adaptive moment estimation. To enhance robustness and accuracy, a data augmentation process may be used in which synthetic variations of pricing scenarios and proposal texts are generated.

The server encodes the prompt sentence and structured data into token sequences and numerical vectors and sends them to the generative AI model via a communication interface. The model performs inference by computing successive output token probabilities based on the input tokens and internal state, generating a text response that includes an analysis result. The analysis result may contain normalized pricing fields, a competitiveness assessment, a recommendation for discount adjustments, and an explanatory rationale. The server receives the result, parses it according to a predefined pattern or marker tokens, and stores it in an ANALYSIS_RESULT table. The use of structured prompts with explicit fields reduces the variability of responses and allows the server to reliably map segments of the generated text to database fields, which directly improves processing accuracy and reduces post-processing complexity.

The server automatically generates or supplements a proposal document including an optimal pricing scheme based on the analysis result and the determination result. A document generation module of the server reads candidate schemes and AI-recommended adjustments, chooses or computes an optimal pricing scheme according to internal criteria stored in a CONFIG_POLICY table, and then updates a representation of the proposal. In one embodiment, the server represents proposal documents as a template with placeholders, and fills those placeholders using the optimal pricing values and textual justifications retrieved from the analysis result. The server then writes a new version of the document to the document store and updates version information in the PROPOSAL table. The terminal can download and display this updated document to the user.

The server automatically generates approval request data including a discount rate, a discount reason, and a discount period when the system determines that a relative adjustment is required. The approval request generation module of the server constructs an approval record in an APPROVAL_REQUEST table, setting fields such as proposal identifier, requested discount rate, calculated final price, discount period, and an explanation text derived from the analysis result. The server formats this data into a message structure required by an internal business system, such as a workflow engine or enterprise resource planning system, and sends the message via a messaging protocol. The internal system uses the request to perform its own approval processing. By generating approval data directly from structured analysis results, the server avoids redundant parsing and manual intervention, thereby reducing latency and error rates in the approval pipeline.

The server records the proposal document, the analysis result, and the approval request data in association with one another in the storage device. The server maintains foreign key relationships across the PROPOSAL, STRUCTURED_PRICING, ANALYSIS_RESULT, and APPROVAL_REQUEST tables, enabling efficient retrieval of all related data in a single query. When a user accesses a proposal from the terminal, the server joins these tables and presents a unified view through the user interface backend. The terminal renders this information so that the user can inspect the original proposal, the computed pricing analysis, and the status and details of any approval request.

The server supports dynamic re-analysis driven by the terminal. When the user modifies pricing fields, adjusts assumptions, or enters additional constraints via the user interface, the terminal sends updated parameters or instructions to the server. The server constructs a modified prompt sentence that explicitly incorporates the user changes and refers to previously stored structured data, instead of re-parsing the entire document. This prompt sentence may specify, for instance, that only certain discount ranges are allowed or that a particular competitor should be emphasized. Because the server selectively reuses previously extracted structured data, the re-analysis requires fewer computational resources and less network bandwidth than re-running the full pipeline, resulting in improved processing speed and reduced load on both the server and the generative AI model infrastructure.

This configuration yields technical effects beyond mere automation of human tasks. By transforming heterogeneous, unstructured documents and external offering information into normalized, indexed data structures, the server reduces the need for repeated document parsing and unstructured searches. The use of a layered neural architecture and explicit token labeling to identify pricing-related tokens improves extraction accuracy compared to pattern-based parsing alone. The integration of a generative AI model through carefully structured prompt sentences, rather than generic free-form prompts, improves determinism and reduces response variance, enabling downstream modules to rely on stable field extraction. This in turn reduces error handling overhead and rerun rates, improving processor utilization.

Furthermore, the server implements a non-conventional processing flow in which rule-based determination of whether a relative adjustment is needed precedes the sending of large payloads to the generative AI model. This screening step, executed using data in the CANDIDATE_SCHEME and PRICING_RULE tables, reduces the number of external inference calls, thereby decreasing network traffic, latency, and computing resource consumption at the model host. The causal relationship between the rule-based screening and reduced computational usage is direct: only records with the adjustment-required flag set are subjected to high-cost AI inference.

In addition, the training and fine-tuning of the generative AI model on domain-specific pricing sequences, together with the use of structured prompts that include explicit field markers, reduce the cross-entropy loss on pricing-related tokens compared to general-purpose language models. Consequently, the model outputs more accurate and concise analyses, which the server can directly map to database fields without complex natural language understanding routines. This contributes to error reduction and lower probability of misclassification of pricing conditions.

The server may employ alternative embodiments of the generative AI model. In one embodiment, the model is a sequence-to-sequence transformer with encoder and decoder components, where the encoder ingests structured pricing data and competitor summaries encoded as textual sequences, and the decoder generates an analysis narrative and recommended values. In another embodiment, the model uses a mixture-of-experts architecture, where different expert subnetworks handle different product categories or markets, and a gating network selects the appropriate expert based on category tokens embedded in the prompt sentence. These architectural variations provide further improvements in inference speed and specialization, which are realized at the server level as reduced processing time for specific domains.

In further embodiments, the server may adjust model parameters or decoding parameters such as temperature, top-k sampling, or beam width based on proposal complexity measured from structured data fields. For example, for simple proposals involving a single item, the server may use a smaller beam width to accelerate inference, whereas for complex multi-line proposals it may allocate more decoding resources. By dynamically controlling these parameters, the server optimizes resource allocation for the generative AI model and achieves improved overall system throughput.

The terminal and user may interact with the system in various ways. The user may initiate scenario analysis by specifying hypothetical competitor pricing or modified discount policies through an interface component. The terminal sends these hypothetical constraints to the server, which updates the structured data and regenerates prompt sentences accordingly. The system thus enables what-if simulations without requiring the user to re-author entire proposal documents. The technical advantage is that the server can reuse existing structured representations and model weights to generate new analyses with minimal recomputation. Alternative implementations may employ different database technologies, such as columnar stores for analytical queries, or different natural language processing frameworks, as long as the core data flow and modular architecture are maintained. The essential technical features are that the server transforms proposal and offering information into structured, indexed data; applies a combination of rule-based and neural network-based processing; constructs and transmits structured prompt sentences to a generative AI model; and generates and persists related proposal, analysis, and approval data in a manner that reduces redundancy, improves efficiency, and enhances the performance of the computing system as a whole.

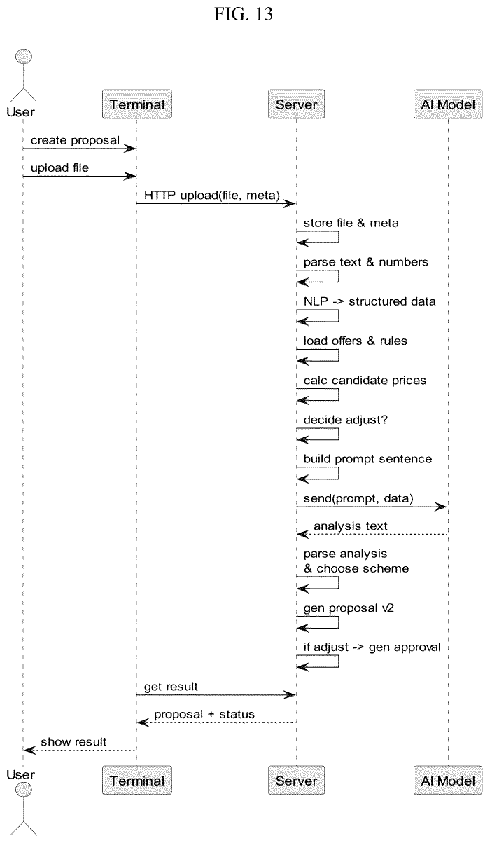

The following describes the processing flow using FIG. 13.

Step 1:

The user creates a proposal document on the terminal.

The user inputs product or service descriptions, base prices, discount rates, contract durations, and conditions into an editing application on the terminal. The terminal takes, as input, the user's keystrokes and selection operations, and outputs a proposal document file in a format such as DOCX or PDF stored in a local file system. The terminal then sends the file and associated metadata (such as customer name and proposal title) to the server via a secure upload form.

Step 2:

The server receives and stores the proposal document.

The server takes, as input, an HTTP request containing the proposal document file and metadata from the terminal. The server verifies user authentication, checks the file type and size, and writes the raw file into a document store in the storage device. The server creates a proposal record in a database table with fields such as proposal_id, file_path, user_id, and timestamp. The output of this step is a stored file reference and a corresponding proposal record ready for further processing.

Step 3:

The server extracts text and numerical information from the proposal document.

The server reads, as input, the stored file referenced by the proposal record. The server selects a parsing method based on the file type: for editable documents, the server uses a document parsing library; for scanned documents, the server uses an optical character recognition engine. The server converts the binary file content into plain text segments and detects tables and structural markers. The server parses the text to identify candidate numeric tokens (such as currency amounts, percentages, and durations) using pattern-matching and locale-aware number parsers. The server outputs a set of text segments and extracted numeric tokens, and stores them in intermediate tables linked to the proposal_id.

Step 4:

The server applies natural language processing to create structured pricing data.

The server takes, as input, the text segments and numeric tokens associated with the proposal_id. The server loads parameters of a neural sequence labeling model, converts each token into an embedding vector, and executes multiple attention and feedforward layers to compute contextual representations. The server assigns labels (for example, PRICE, DISCOUNT_RATE, DISCOUNT_REASON, CONTRACT_DURATION, CONDITION) to tokens using a classifier head. The server aggregates labeled tokens into entities by grouping contiguous segments and normalizes values (for example, converting text “10%” into a numeric 0.10). The server outputs structured entries containing fields such as base_price, discount_rate, discount_reason, discount_period, and contract_duration, and writes these entries into a structured_pricing table keyed by proposal_id.

Step 5:

The server acquires and normalizes information relating to offerings provided by other organizations and by an own organization.

The server takes, as input, external offering data files or messages from external systems and internal offering data from internal business databases. The server maps varying field names and formats into a unified schema, converts currencies if necessary, and assigns standardized product category identifiers. The server computes summary statistics for each product category, such as average competitor price and minimum competitor price, and stores these summaries in competitor_summary and internal_standard tables. The output is a set of normalized offering records and summaries that can be directly joined with the structured pricing data.

Step 6:

The server computes candidate pricing schemes based on structured data and offering summaries.

The server takes, as input, structured_pricing records for a given proposal_id and related competitor_summary and internal_standard records. The server joins these tables on product identifiers or mapped categories and executes arithmetic computations to calculate candidate prices and discounts. For example, the server may compute a candidate price as internal_standard_price minus a recommended discount derived from competitor deltas and internal rules. The server writes candidate_scheme records that include, for each line item, fields such as suggested_price, suggested_discount_rate, margin_estimate, and justification_code. The output is a list of candidate schemes linked to the proposal.

Step 7:

The server determines whether a relative adjustment of the pricing scheme is required.

The server takes, as input, candidate_scheme records and pricing rules stored in a pricing_rule table. The server evaluates each candidate_scheme against thresholds and conditions, such as a required competitiveness margin or minimum profit constraints, via logical operations and comparisons. If a candidate_scheme falls outside allowable ranges or is uncompetitive compared to competitor_summary, the server sets an adjustment_required flag. The server outputs a determination result for each candidate_scheme and updates the candidate_scheme table with this status.

Step 8:

The server constructs a prompt sentence for a generative AI model.

The server takes, as input, the structured_pricing data, competitor_summary and internal_standard summaries, and the determination results from candidate_scheme records. The server formats these data into short textual descriptions and embeds them into a prompt template. The server concatenates an instruction part, a section summarizing proposal data, and sections describing other organizations'offerings and own offerings. For example, the server creates a prompt sentence such as:

“You are an AI assistant specialized in B2B pricing analysis. Analyze the following proposal data and competitor summary. Extract any missing pricing details, evaluate whether the proposed prices are competitive, and decide whether a relative price adjustment is required. If an adjustment is required, recommend a new discount rate, discount period, and discount reason consistent with the internal policy described below.”

The output of this step is a composed prompt sentence and a compact representation of the structured data ready for transmission to the generative AI model.

Step 9:

The server transmits the prompt sentence and analysis target data to the generative AI model and receives an analysis result.

The server takes, as input, the generated prompt sentence and the analysis target data comprising structured_pricing entries and offering summaries. The server encodes these as an API request payload, opens a network connection to the generative AI model service, and sends the data over a communication interface. The generative AI model performs inference and returns a generated text response that contains an analysis, including recommended discount rates, discount periods, and rationales. The server receives the response, parses the text using delimiters or patterns defined in the prompt, and converts relevant parts into structured fields. The output is an analysis_result record containing fields such as competitive_assessment, recommended_discount_rate, recommended_discount_period, discount_reason, and explanation_text.

Step 10:

The server generates or supplements a proposal document including an optimal pricing scheme.

The server takes, as input, analysis_result records, candidate_scheme records, and the original proposal template referenced by proposal_id. The server evaluates multiple candidate_scheme options in light of the analysis_result, selecting an optimal pricing scheme that satisfies both competitiveness and internal constraints. The server then substitutes price and discount placeholders in a document template with the selected values and adds or updates explanatory text based on explanation_text from the analysis_result. The server writes a new version of the proposal document to the document store and updates the proposal record with a reference to this version. The output is an updated proposal document file that integrates the optimized pricing scheme.

Step 11:

The server generates approval request data when a relative adjustment is required and transmits it to an internal business system.

The server takes, as input, analysis_result records with recommended discounts, candidate_scheme records with adjustment_required flags, and policy constraints. For each proposal line where adjustment_required is true, the server composes an approval_request entity that includes fields such as proposal_id, product identifiers, requested_discount_rate, final_price, discount_period, and discount_reason. The server serializes this entity into the required message format and sends it through a communication interface (such as a web service endpoint) to an internal business system. The output consists of transmitted approval request messages and corresponding approval_request records stored in a database table.

Step 12:

The server records associations among the proposal document, the analysis result, and the approval request data and provides them to the terminal.

The server takes, as input, identifiers for the proposal, the stored analysis_result, and any approval_request records. The server maintains foreign key relationships and updates join tables so that a query by proposal_id retrieves all related records. When the terminal requests proposal details, the server executes a database query that joins proposal, structured_pricing, analysis_result, and approval_request tables. The server formats the combined data into a response, including pricing fields, AI analysis summaries, and approval statuses. The terminal receives this response and displays the unified information to the user. The output of this step is a consolidated view presented on the terminal that allows the user to understand the pricing decision and approval status without re-running the entire analysis pipeline.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional pricing proposal systems and document generation tools largely rely on static business rules and manually crafted texts. In such systems, a processor typically performs straightforward arithmetic comparisons between competitor billing information and internal pricing tables, and then a human operator composes or edits a proposal document. As a result, several technical problems arise in the processing pipeline executed by the computer system.

First, when billing information is heterogeneous, partially missing, or embedded in semi-structured or unstructured documents, conventional systems require manual normalization and extraction. The processor cannot reliably transform diverse billing inputs into structured data without significant human intervention, which increases latency, reduces throughput, and limits scalability.

Second, existing systems do not have an integrated mechanism to programmatically generate, control, and reuse prompt sentences for a generative AI model in a manner that is tightly coupled with internal structured data (such as pricing comparison results and discount decisions). Instead, generative AI is often invoked in an ad-hoc fashion with manually written prompts, leading to non-deterministic outputs, difficulty in aligning generated text with computed values, and increased risk of inconsistency between the numerical content calculated by the processor and the narrative content generated by the model.

Third, conventional workflows for discount approval are typically separated from the pricing computation and document generation logic. A processor may calculate a potential discount but has limited capability to automatically determine approval necessity based on machine-readable internal rules, initiate an approval workflow in an external business processing system, and then consistently propagate the approval result back into the proposal document without manual editing. This separation introduces synchronization errors and delays and burdens human operators.

Fourth, while some systems can perform sentiment analysis as an add-on, they do not integrate emotion analysis as a first-class input to control the generation and adaptation of proposal content. In many implementations, emotion or sentiment outputs are merely displayed to the operator, rather than being used by the processor to dynamically adjust the parameters of prompt sentences and the level of detail, tone, and emphasis in the generated text. As a consequence, the system cannot automatically tailor explanations and discount presentations to the user's emotional state, limiting the effectiveness and responsiveness of the user interaction.

Accordingly, there is a need for a technical solution in which a processor, operating as part of a server, transforms raw billing information and user interaction signals into structured data, generates and controls prompt sentences for a generative AI model in a data-driven manner, tightly constrains the generative AI outputs to the system's computed results, automatically manages discount approval workflows, and dynamically adapts generated proposal content based on emotion analysis. Such a solution should improve the efficiency, consistency, and reliability of the overall computer-implemented pricing proposal pipeline, thereby constituting an improvement in computer technology itself rather than a mere automation of a human mental process.

The specific processing by the specific processing unit 290 of the data processing device 12 in Application Example 2 is realized by the following means.

The present invention provides a server comprising a processor configured to acquire billing information regarding a service provided by another provider, store the billing information in a data storage device, and analyze the billing information to calculate, from among a plurality of pricing schemes provided by an own provider, a pricing scheme having high economic efficiency for a user; to generate structured data including at least the billing information and information regarding the plurality of pricing schemes, calculate a pricing comparison result and a necessity of discount based on the structured data, and generate skeleton information of a proposal document based on the pricing comparison result; to generate draft text of the proposal document by executing template processing and natural language processing using the skeleton information of the proposal document; to dynamically generate, based on at least one of the billing information, the pricing comparison result, the necessity of discount, and the draft text, a prompt sentence to be input to a generative AI model, input the prompt sentence and the skeleton information of the proposal document to the generative AI model, obtain output text for reinforcing explanatory content or expression content of the proposal document from the generative AI model, and incorporate the output text into the proposal document; to determine a necessity of discount approval based on a discount rate calculated from the billing information and the pricing comparison result and on threshold information stored as internal rules, when the discount approval is determined to be necessary, generate approval request data including at least the pricing comparison result and the output text obtained from the generative AI model, automatically transmit the approval request data to a business processing system to start an approval workflow, obtain an approval result from the business processing system, and update pricing conditions described in the proposal document based on the approval result; and to execute emotion analysis processing on at least one of text information, voice information, and image information acquired from the user to estimate an emotion state of the user, and, based on the emotion state and the pricing comparison result, dynamically adjust at least one of content of the prompt sentence to be input to the generative AI model, a level of detail, tone, and emphasis items of explanatory text in the proposal document, and generate a proposal document in which at least one of a discount rate, an expression of a proposal reason, and an amount of presented information is changed according to the emotion state. This enables the server to implement a technically improved pipeline in which heterogeneous billing data are normalized and structured, prompt sentences for the generative AI model are automatically and consistently constructed from internal computation results, generative outputs are constrained and merged with deterministic numerical content, discount approval workflows are automatically coordinated with external business systems, and proposal documents are adaptively generated in real time according to the user's emotional state, thereby enhancing computational efficiency, data consistency, and responsiveness of the computer-implemented pricing proposal system.

The term “billing information” refers to data representing charges, usage quantities, time periods, options, taxes, or other chargeable elements associated with a service provided by another provider, including information extracted from structured, semi-structured, or unstructured records such as invoices or statements.

The term “data storage device” refers to any hardware or logical storage resource capable of persistently or temporarily storing digital data, including but not limited to magnetic storage, solid-state storage, optical storage, or a logical database implemented thereon.

The term “pricing scheme” refers to a structured set of parameters defining how charges are calculated for a service, including at least one of a base fee, usage-dependent fees, included allowance, discount conditions, or contract duration.

The term “economic efficiency” refers to a measure of cost performance for a user with respect to one or more pricing schemes, typically expressed in terms of lower total cost, improved value per unit of usage, or improved cost over a given time period under specified usage conditions.

The term “structured data” refers to data that are organized in a predefined format, such as key-value pairs, tables, or records, enabling programmatic access and computation by a processor without human interpretation.

The term “pricing comparison result” refers to information indicating a comparative evaluation between at least two pricing schemes, including numerical or categorical values representing cost differences, savings, or relative advantages for a given usage pattern.

The term “necessity of discount” refers to an evaluation result indicating whether a discount should be applied to a pricing scheme, and, in some examples, further indicating an amount or rate of the discount considered appropriate based on one or more rules or models.

The term “skeleton information of a proposal document” refers to intermediate data describing a structural framework of a proposal document, including sections, headings, key numeric values, and placeholders for narrative text, prior to generation of fully natural-language content.

The term “proposal document” refers to a document intended to present one or more pricing schemes, comparison results, discount conditions, or justifications to a user or client, and including at least structured numerical information and explanatory text.

The term “template processing” refers to processing in which a processor combines predefined document templates with structured data to automatically generate text or layout, typically by replacing placeholders with computed values or generated content.

The term “natural language processing” refers to computational techniques that analyze, generate, or transform human language text, including tokenization, syntactic or semantic analysis, or automatic text generation based on input data.

The term “draft text” refers to preliminary natural-language content for a proposal document generated automatically by the processor, prior to refinement or reinforcement by a generative AI model.

The term “generative AI model” refers to a trained computational model configured to generate natural-language text or other content in response to an input, the model having been trained on data so as to produce contextually coherent outputs given an input prompt.

The term “prompt sentence” refers to an input sequence of natural-language tokens, optionally including embedded structured data, provided to a generative AI model to control or condition the content, style, or scope of the model's output.

The term “output text” refers to text generated by the generative AI model in response to a prompt sentence and used to reinforce, extend, or modify explanatory or expressive portions of a proposal document.

The term “electronic file format” refers to a digital representation of a document encoded according to a predefined file specification, such as a portable document format, a word processing format, or an equivalent structured document format.

The term “communication unit” refers to a hardware and/or software component that enables transmission and reception of digital data between the server and external devices over one or more communication networks.

The term “user terminal” refers to an electronic device operated by or on behalf of a user, such as a computing device, a mobile device, or any other client device capable of communicating with the server and presenting proposal documents.

The term “client terminal” refers to a user terminal associated with a recipient of a proposal document, including but not limited to a device used by a customer, prospect, or internal stakeholder to view or respond to a proposal.

The term “discount approval” refers to authorization by an internal process or system to apply a particular discount rate, discount amount, or special pricing condition to a pricing scheme.

The term “threshold information” refers to machine-readable data defining one or more numerical or categorical criteria, such as maximum discount rates or minimum margin levels, used to determine whether additional approval or processing is required.

The term “approval request data” refers to data generated by the processor that describes a proposed discount or pricing change, including at least a pricing comparison result and associated justification, and that is transmitted to an external business processing system to request approval.

The term “business processing system” refers to an information processing system operated within an organization to manage business workflows, including at least approval processes, record keeping, or contract management.

The term “approval workflow” refers to a sequence of computer-implemented processing steps executed by the business processing system or a related system, in which an approval request is routed, evaluated, and either approved or rejected, and in which an approval result is generated.

The term “emotion analysis processing” refers to computational processing that estimates an emotional state of a user from input data such as text, voice, or image signals, using statistical, rule-based, or machine-learning methods.

The term “emotion state” refers to a classification or quantitative representation of a user's emotional condition, such as satisfaction, dissatisfaction, confusion, or confidence, as inferred by emotion analysis processing.

The term “text information” refers to character-based data produced by or associated with a user, including input messages, comments, or other textual interactions.

The term “voice information” refers to audio data representing spoken utterances by a user, suitable for analysis of acoustic features such as pitch, intensity, and prosody.

The term “image information” refers to visual data such as still images or video frames depicting a user, suitable for analysis of facial expressions or other visual cues.

The term “level of detail” refers to a degree of specificity or granularity in explanatory text, including the amount of technical information, numerical breakdowns, or step-by-step explanations provided.

The term “tone” refers to stylistic characteristics of text, such as formality, directness, friendliness, or emphasis, as perceived by a reader.

The term “emphasis items” refers to particular elements of content, such as savings figures, risk reduction statements, or feature highlights, that are selectively stressed or de-emphasized in the explanatory text.

The term “amount of presented information” refers to a quantity or scope of information exposed in a proposal document, including number of sections, length of explanations, and density of numerical data or comparisons.

Server in one embodiment includes at least one processor, a main memory storing program instructions and data structures, a non-volatile storage device implementing a database, and a communication interface connected to one or more networks. Server executes a program that realizes the functions defined in the claims by coordinating several software modules, including a web application framework (for example, a framework corresponding to Flask), a data analysis library (for example, a library corresponding to Pandas and NumPy), a machine learning library (for example, a library corresponding to Scikit-learn), a deep learning framework (for example, a framework corresponding to TensorFlow), a natural language processing library (for example, a library corresponding to spaCy or NLTK), a document generation library (for example, a library corresponding to python-docx, ReportLab, or PDFKit), and communication and mail libraries (for example, components corresponding to HTTP handling and SMTP handling).

Terminal in one embodiment is realized as a client device such as a smartphone, a tablet computer, or a personal computer. Terminal provides a graphical user interface implemented by a web browser or a native application. Terminal comprises an input unit, a display unit, a local storage, and a communication unit. Terminal transmits billing information and user interaction data to server and receives generated proposal documents and associated metadata from server.

User operates terminal to supply billing information and feedback. User may upload competitor invoices as CSV, spreadsheet, or PDF files, or may manually enter monthly fees, usage volumes, and option information through form fields. User may also enter free-text comments and, in some embodiments, allow collection of voice or image information for emotion analysis.

Server in one embodiment stores billing information received from terminal in a relational database managed by a database management system. Server defines specific database tables in the storage device, for example: a “billing_raw” table containing raw billing records, a “billing_normalized” table containing normalized billing entries, a “plans_internal” table containing definitions of internal pricing schemes, a “proposal_meta” table containing metadata for generated proposals, a “discount_decision” table containing computed discount rates and approval states, and a “user_emotion” table containing emotion analysis results. Each table has defined columns, such as user identifier, service identifier, time period, base fee, per-unit charge, usage amount, and plan identifier. By normalizing billing information into fixed schemas, server enables vectorized computation and efficient indexing, thereby improving processing speed and reducing memory overhead.

Server uses the data analysis library to transform raw billing information into structured data. Server reads raw records from the billing_raw table into data frames, converts textual representations of currency, time units, and data units into normalized numeric values, and constructs feature vectors that represent usage patterns. Server performs these operations using column-wise operations and vectorized arithmetic, which greatly reduces the number of iterations required compared to row-wise or manual processing. This structure leads to improved throughput and lower CPU utilization on large batches of billing data.

Server in one embodiment implements a machine learning model for determining a pricing comparison result and a necessity of discount. Server constructs feature vectors containing at least the following elements: normalized competitor cost, base fees and variable fees of internal pricing schemes, estimated usage distribution across time, user segment indicators, historical acceptance of previous offers, and previous discount levels applied to similar users. Server uses Scikit-learn-type algorithms such as random forests, gradient boosting trees, or support vector machines to train a model on historical labeled data. Labels include optimal plan selection and whether a discount was required to win a contract. Server uses a cost-sensitive loss function so that misclassification of high-value customers incurs higher penalties than misclassification of low-value customers. During training, server performs cross-validation, hyperparameter tuning, and feature importance analysis to optimize predictive performance and avoid overfitting. By encapsulating this model inside the server, the system can automatically infer which pricing schemes are economically efficient and whether discounts are needed for new billing cases, improving accuracy and consistency over simple rule-based threshold comparisons.

Server optionally uses a deep learning framework to implement a neural network model for more complex prediction tasks, such as long-term plan recommendation from time-series payment histories. Server defines a neural network architecture that may include an input layer receiving a fixed-length sequence of monthly feature vectors, one or more recurrent layers (for example, long short-term memory layers) or one-dimensional convolutional layers to capture temporal patterns, and fully connected layers that output probabilities for each internal plan being optimal. Server trains this network using a loss function such as cross-entropy, and updates weights by backpropagation with stochastic gradient descent or an adaptive optimizer. Server applies regularization techniques such as dropout or weight decay and may perform data augmentation by injecting noise into usage patterns within realistic ranges. These details of the model structure and training procedure provide a concrete implementation for the “necessity of discount” and “pricing scheme having high economic efficiency” determinations, which go beyond generic “AI decides” descriptions.

Server constructs structured data for document generation. Server composes a “proposal skeleton” object in memory that contains fields for customer summary, competitor pricing summary, internal plan candidates, savings amounts, computed discount rates, and section identifiers for explanation blocks. This skeleton is represented as a structured data object, such as a nested map or an in-memory record, that can be serialized and stored in the proposal_meta table. By clearly separating numeric skeleton information from natural-language text, server ensures that numerical values remain authoritative and can be reused or revalidated independently of later textual generation.

Server then uses a template engine to generate draft text for the proposal document. Server loads predefined templates stored in the storage device, where templates contain placeholder tokens for numeric values, plan names, and explanatory sentences. Server binds the skeleton information to these templates and converts them into a first version of proposal text. This operation is purely deterministic and allows server to guarantee that all critical numeric values in the proposal match the underlying computation. This separation between numeric computation and language generation is an important technical design that reduces the risk of inconsistencies often associated with generative models.

Server uses a generative AI model to refine and enrich the draft text. Server does not simply call a large model with arbitrary instructions; instead, server constructs prompt sentences in a controlled manner from the structured skeleton and draft text. For example, server may construct the following prompt sentence:

“Using the following pricing summary, write a concise explanation for the customer that justifies a 15% relative discount compared to their current 10,000 yen competitor plan. Do not change any numbers. Pricing summary: [structured summary text].”

In another example, server may construct a prompt sentence for simplifying explanations:

“Explain the following pricing comparison in simple language suitable for someone not familiar with telecom tariffs. Keep all numeric values exactly the same: [detailed comparison text].”

In another example for proposal refinement, server may generate a prompt sentence:

“Rewrite the following pricing proposal section to be clear and persuasive for a non-technical business decision maker. Do not modify any amounts or plan names: [draft section text].”

By encoding explicit constraints such as “Do not change any numbers” or “Keep all numeric values exactly the same,” server uses the generative AI model in a non-conventional way to preserve numeric integrity. After obtaining output text from the generative AI model, server parses the output to verify that numeric values match the original skeleton. Server may compare numbers by scanning for numeric tokens and checking them against stored values. If discrepancies are detected, server can discard the generated text or correct only the narrative while reverting numeric tokens to original values. This post-processing step uses deterministic algorithms (for example, pattern matching and numeric comparison) and ensures that the generative AI model cannot corrupt the computational results. Thus, the system leverages generative AI while maintaining strict data consistency, which is a technical improvement over conventional unstructured model usage.

Server determines necessity of discount approval through a rule engine that combines model outputs with threshold information loaded from a configuration table. Server receives a recommended discount rate from the prediction model, compares it against multiple thresholds depending on user type, plan type, and margin constraints, and classifies the discount as “no approval needed,” “manager approval needed,” or “executive approval needed.” Server then constructs an “approval request” object containing fields for case identifier, computed discount rate, reason code, predicted win probability, and the generative AI-produced justification text. Server transmits this object through a communication interface to a business processing system implementing a workflow engine. The workflow engine may be orchestrated by a framework similar to an enterprise workflow manager. Server subsequently receives approval results, which the business processing system returns via a network. Server updates the discount_decision table accordingly and uses this status to modify the proposal skeleton. For example, if approval granted a higher discount than initially requested, server updates the discount rate field and recalculates savings values, thereby automatically propagating the new numbers into any downstream documents. This automated closed-loop design reduces human editing errors and ensures that the document content is always synchronized with the latest approved internal conditions.

Server performs emotion analysis to adapt proposal content. Server receives user text comments from terminal and may also receive metadata about voice signals or images captured by terminal. Server passes text content to a natural language processing library or external sentiment analysis service that outputs an emotion state such as “negative,” “neutral,” or “positive,” and optionally more detailed categories. For voice or image data, server uses an emotion recognition engine that analyzes acoustic features or facial expressions and returns quantitative emotion scores (for example, scores for frustration, confusion, satisfaction). Server normalizes these scores and stores them in the user_emotion table.

Server then uses the emotion state to modify the content of subsequent prompt sentences and templates. For example, when the emotion state is “dissatisfied,” server may construct a prompt sentence such as:

“Based on the following pricing summary, draft a proposal paragraph that acknowledges the customer's dissatisfaction and highlights the cost savings and flexibility of the recommended plan. Do not change any numeric values: [pricing summary text].”

When the emotion state is “confused,” server may construct a different prompt sentence:

“Explain these pricing options in very simple language and with short sentences, suitable for a user who is confused about pricing. Keep all amounts and plan names unchanged: [pricing options text].”

Server also selects among multiple templates that have different levels of detail and tone. For instance, for satisfied users, server chooses a shorter, confirmation-oriented template; for confused users, server chooses a template that includes an FAQ-style section and additional visual aids. This combination of emotion analysis and controlled generative prompts allows the system to adapt the length, complexity, and tone of the text in an algorithmically defined way, resulting in improved user comprehension and engagement while still being performed by concrete data structures and conditional logic within server.

Terminal uses its display unit to present proposal documents received from server to user. Terminal may show an HTML representation in a browser or render a PDF file obtained from server using a PDF viewer component. Terminal can also present interactive elements, such as buttons to accept a plan, to request further explanation, or to trigger a deeper discount request. When user interacts with these elements, terminal packages the event data and sends corresponding requests to server. Thus, terminal acts as a controlled interface through which server obtains feedback that informs emotion analysis and further system processing.

Server generates the final proposal document in an electronic file format suitable for distribution. Server uses a document generation library to convert the proposal skeleton and combined text (template-based text plus generative AI-refined text) into a structured document. Server may generate word processor documents or portable document format files, embedding tables, headings, and graphs. Server saves these files in the storage device and associates file identifiers with the corresponding entries in the proposal_meta table. Server then either sends download links or attaches the files when sending emails through an email-sending library.

This system provides several technical effects. Because server transforms heterogeneous billing data into normalized structured data using vectorized operations and stores them in indexed tables, server can process large volumes of invoices quickly and consistently, which constitutes a concrete improvement in data processing efficiency. Because server uses a trained predictive model with specified architecture and feature design, decision-making about optimal pricing schemes and discount necessity becomes more accurate and less dependent on hard-coded rules. This reduces numeric error and allows the system to better scale to varied usage patterns.

Moreover, the combination of template-based deterministic content and constrained generative output, enforced by prompt design and numeric validation, provides a technical architecture that alleviates the usual risks of unconstrained generative models. In particular, server ensures that all numeric values in the final proposal are consistent with underlying computations, thereby preventing so-called “hallucination” of numbers. This approach improves data integrity and reliability in automated document generation and goes beyond merely automating human writing.

The automatic coordination with a business processing system for discount approval is implemented through machine-readable approval thresholds, structured approval objects, and state updates managed by server. This integration reduces communication overhead and eliminates manual synchronizing of discount decisions and document contents. As a result, the probability of inconsistency between approved pricing conditions and communicated offers is lowered, demonstrating a reduction in execution error that is rooted in the design of the data structures and algorithms executed by server.

The emotion-aware adaptation of both prompt sentences and templates constitutes an improvement in the computing system's ability to present complex pricing information in a way that is aligned with user state. Because server uses quantifiable emotion scores as input to deterministic logic that selects prompt types, template variants, and text detail levels, the system can deliver clearer explanations to users who might otherwise misunderstand the proposal. This effect can be measured as a reduction in follow-up interactions or clarification requests, which is a technical improvement in the quality and efficiency of the human-computer interaction facilitated by the system.

Alternative embodiments can be realized. Server may use different machine learning algorithms, such as gradient boosting frameworks, for discount prediction; server may implement different neural network architectures, such as transformers, for long-term plan recommendation; server may store data in column-oriented databases instead of row-oriented relational databases. Terminal may be realized as any network-capable device, including embedded systems or dedicated kiosks. Emotion analysis may operate solely on text, solely on voice, or on multimodal data, with different feature extraction techniques. Generative AI models may be deployed locally on server or accessed through remote computing resources, provided that server maintains control over prompt sentences and enforces numeric validation on outputs.

In all embodiments, server executes concrete data manipulations, model inferences, template processing, prompt generation, and numeric validation procedures inside a defined hardware and software architecture. The system thereby provides a computer-implemented improvement to the way pricing proposals are computed and generated, rather than simply executing abstract business logic or textual operations.

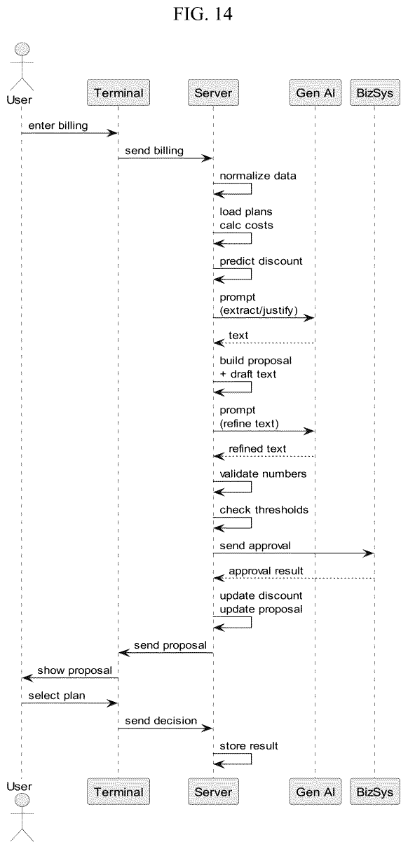

The following describes the processing flow using FIG. 14.

Step 1:

User operates terminal to provide billing information and context.

User selects an input function on terminal and either uploads competitor invoices as files or types values such as monthly fee, usage amount, and option details into input fields. Input is one or more files (for example, CSV, spreadsheet, PDF) and/or form values. Output from this step is a set of raw billing data and metadata packaged by terminal into a request for server.

Step 2:

Terminal transmits raw billing data to server.

Terminal validates file types and mandatory fields locally and then sends an HTTP request over a network to server, embedding billing data and user identifiers in a request body (for example, JSON or multipart data). Input is the user-provided billing data; output is a network message delivered to server containing the same data in a machine-readable format.

Step 3:

Server receives and persists raw billing data.

Server accepts the incoming HTTP request, parses headers and body, and extracts billing records and identifiers. Server performs basic integrity checks (for example, file size limits, presence of required keys) and then writes records into a “billing_raw” table in a database. Input is the network message from terminal; output is stored raw billing rows with primary keys, ready for further processing.

Step 4:

Server normalizes and structures billing data.

Server loads the raw records from the “billing_raw” table into a data frame structure. Server converts currencies, time units, and data units into unified numeric forms and maps textual item descriptions to standardized internal codes. Input is raw billing rows; output is a normalized data structure stored in a “billing_normalized” table, with columns such as user_id, period, base_fee, variable_fee, and usage_volume. Server performs data processing by applying vectorized arithmetic operations and mapping tables to transform the raw inputs into consistent, comparable values.

Step 5:

Server extracts key values from unstructured invoice text using a generative AI model.

Server detects that some invoices are PDFs or semi-structured documents and uses a text extraction component to obtain plain text. Server then constructs a prompt sentence instructing a generative AI model to extract specific fields. For example, server may generate the prompt sentence:

“Extract monthly fee, usage volume, contract term, and option names from the following invoice text and return them in plain text as labeled values.”

Input is raw invoice text; server sends the prompt sentence and text to the generative AI model and receives a response containing labeled values. Server parses the response and adds extracted values to the normalized data structure. Output is an enriched normalized dataset where previously unstructured items are now represented as explicit numeric and categorical features. Data processing here consists of text extraction, prompt construction, generative inference, and parsing of the generated output back into structured fields.

Step 6:

Server loads internal pricing schemes and prepares feature vectors.

Server retrieves all candidate internal pricing schemes from a “plans_internal” table and loads them into memory as structured records. Server then joins normalized billing data with plan records to form feature vectors that represent projected costs under each internal plan. Input is normalized billing records and internal plan definitions; output is a set of feature vectors, each including fields such as user usage, competitor cost, plan base fee, per-unit fee, and eligibility flags. Server performs this operation using table joins and computed columns that derive cost-relevant attributes from the raw inputs.

Step 7:

Server computes costs and identifies economically efficient plans.

Server applies deterministic cost formulas to each feature vector. For example, server calculates total projected cost under each plan as base_fee+max(0, usage_volume−included_allowance) ×per_unit_fee. Input is the feature vectors prepared in the previous step; output is a cost table listing predicted cost for each plan and user. Server then evaluates which plans minimize cost subject to internal constraints (for example, minimum margin) by comparing cost values across plans. Output includes a subset of plans flagged as “candidate optimal” and their associated savings relative to the competitor cost. Data processing consists of numeric computation over arrays and comparison operations to rank and filter plans.

Step 8:

Server predicts necessity and level of discount using a machine learning model.

Server assembles a feature array for discount prediction, incorporating competitor cost, candidate plan cost, savings amount, customer segment markers, and historical response statistics. Server feeds this array into a machine learning model (for example, a trained decision-tree ensemble or neural network) loaded in memory. Input is the structured features; output is a predicted discount probability and a recommended discount rate. Server performs matrix multiplications and non-linear transformations inside the model to map the features to probabilities and rates. Server stores the model output in a “discount_decision” table for later use.

Step 9:

Server constructs skeleton information for a proposal document.

Server builds an in-memory object that represents the structure of the proposal, including sections such as “Current Charges,” “Recommended Plan,” “Cost Comparison,” and “Discount Details.” Input is the candidate plan information, computed savings, and discount recommendation; output is a proposal skeleton with numbered sections, labeled fields, and placeholders for narrative text. Data processing involves mapping each numeric and categorical value to a specific slot in the skeleton and assigning identifiers so that later text generation can refer to these slots.

Step 10:

Server generates a first draft of proposal text using templates.

Server applies a template engine to combine the skeleton information with predefined sentence patterns. Input is the proposal skeleton; output is draft text that describes the current plan, recommended plan, and savings with placeholders already replaced by numeric values. Server executes string substitution and conditional text expansion according to the presence or absence of discount and specific plan features. This produces a mechanically consistent base text, but without stylistic refinement.

Step 11:

Server constructs a prompt sentence and refines proposal text with a generative AI model.

Server extracts key parts of the draft text and the structured comparison summary and constructs a prompt sentence tailored to the current context. For example, server may create:

“Rewrite the following pricing proposal section to be clear and persuasive for a non-technical business decision maker. Do not modify any amounts or plan names: [draft section text].”Input for this step is the draft text and the structured comparison summary. Server sends the prompt sentence and the included text to the generative AI model. Output from the model is refined text with improved clarity and style. Server then verifies that numeric tokens in the refined text match those in the skeleton by parsing the output, extracting numbers, and comparing them against stored values. If a mismatch occurs, server can either correct the text or discard the problematic output. Data processing thus includes prompt generation, generative inference, textual parsing, and numeric validation.

Step 12:

Server determines whether discount approval is required and prepares an approval request.

Server reads the recommended discount rate from the discount_decision table and compares it with threshold values stored in a configuration table. Input is the discount recommendation and threshold rules; output is an approval status such as “no approval required” or “approval required.” When approval is required, server compiles an approval request record containing case identifiers, competitor cost, internal plan cost, requested discount, and a textual justification (which may include the refined generative text). Server stores this record and transmits it to an external business processing system over a network. Data processing here includes rule-based classification and packaging of structured fields and text into a single approval request object.

Step 13:

Server updates proposal content based on approval results.

Server receives a response from the business processing system indicating approval or rejection and, if approved, the final authorized discount rate. Input is the approval result message; output is an updated discount_decision entry and modified fields in the proposal skeleton. Server recalculates savings using the approved discount, updates numeric fields in the skeleton, and regenerates only affected text segments if necessary (for example, the part describing the discount percentage). These updates maintain consistency between internal state and user-facing documents.

Step 14:

Server performs emotion analysis on user feedback.

User optionally submits free-text comments or participates in a voice or video interaction through terminal. Terminal sends text, and may send audio or image-based features, to server. Input to this step is the user communication data. Server applies a natural language sentiment classifier to the text and may apply audio or image-based emotion detectors to non-text data. Output is an emotion state, such as “dissatisfied,” “confused,” or “satisfied,” stored in a user_emotion record. Data processing includes feature extraction (for example, tokenization, acoustic feature calculation) and applying trained classification models to output discrete emotion labels or scores.

Step 15:

Server adjusts subsequent prompt sentences and proposal detail based on emotion state.

Server reads the emotion state associated with the user and the current pricing context. Input is the emotion label and the pricing comparison result. Server selects one of several prompt templates and document templates that correspond to different levels of detail and tone. For example, when the emotion is “dissatisfied,” server may construct a prompt sentence:

“Based on the following pricing summary, draft a proposal paragraph that acknowledges the customer's dissatisfaction and highlights the cost savings and flexibility of the recommended plan. Do not change any numeric values: [pricing summary text].”

When the emotion is “confused,” server selects a prompt that asks for simplified explanations. Output is new or modified explanatory text that is appended to or replaces sections of the proposal. Data processing involves conditional selection of templates, updated prompt sentence construction, another generative inference call, and controlled insertion of the resulting text into the proposal skeleton.

Step 16:

Server generates the final proposal document in an electronic file format.

Server takes the fully populated proposal skeleton, including validated numeric values and refined text, and passes it to a document-generation component. Input is the skeleton and associated text; output is a complete document in a format such as a portable document format or word processor format. Server renders tables, headers, and paragraphs, embeds graphs if available, and writes the file to storage. This step involves layout calculation and serialization of content into the chosen binary or structured document format.

Step 17:

Server transmits proposal metadata and documents to terminal and optionally to external destinations.

Server prepares a response for terminal containing a document identifier, access URL, and a short summary. Input is the file location and proposal metadata; output to terminal is a structured response. Server also may send the document as an email attachment through an email-sending component. In both cases, server uses network communication protocols to deliver the document, and transitions the internal proposal state to “delivered.”

Step 18:

Terminal presents the proposal and collects user decisions.

Terminal receives the response from server and, based on the URL or file identifier, either downloads the document or accesses it directly. Terminal opens the document in a viewer and displays it to user. Input is the document or URL; output is a rendered proposal on the display. Terminal also provides interactive controls such as “Accept plan,” “Request revision,” or “Ask for more explanation.” When user makes a selection, terminal sends this decision back to server.

Step 19:

User reviews the proposal and issues a decision.

User reads through the displayed document, including the costs, discounts, and explanations tailored by server. Input to this human step is the visual representation of the proposal; output is user actions such as plan acceptance, rejection, or additional comments entered into fields supplied by terminal. These actions are captured by terminal and forwarded to server.

Step 20:

Server records user decision and finalizes internal state.

Server receives the user's decision message from terminal. Input is the decision type, associated proposal identifier, and any new comments. Server updates records in the proposal_meta and discount_decision tables to reflect the final status (for example, “plan accepted,” “declined,” or “pending revision”). If a plan is accepted, server may also trigger follow-up processes such as service activation in external systems, using structured messages. Output from this step is a consistent internal representation of the completed transaction, including logs of all generated prompt sentences, generative outputs, approval actions, and emotion-based adaptations.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

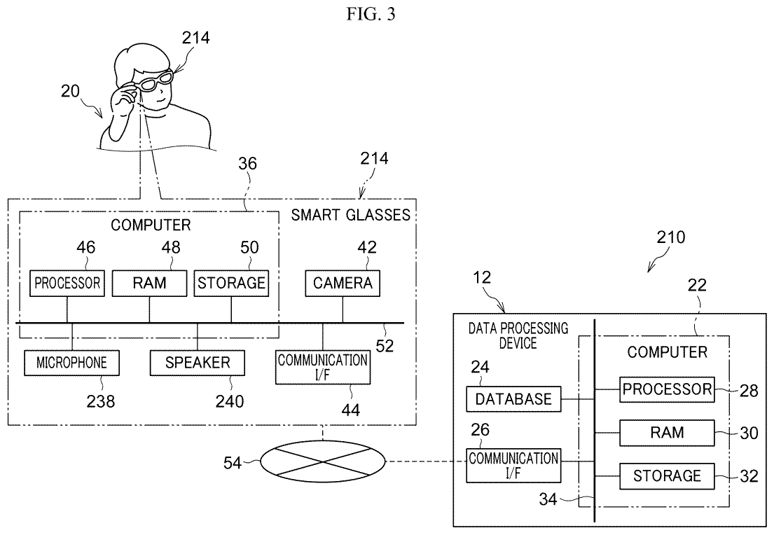

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

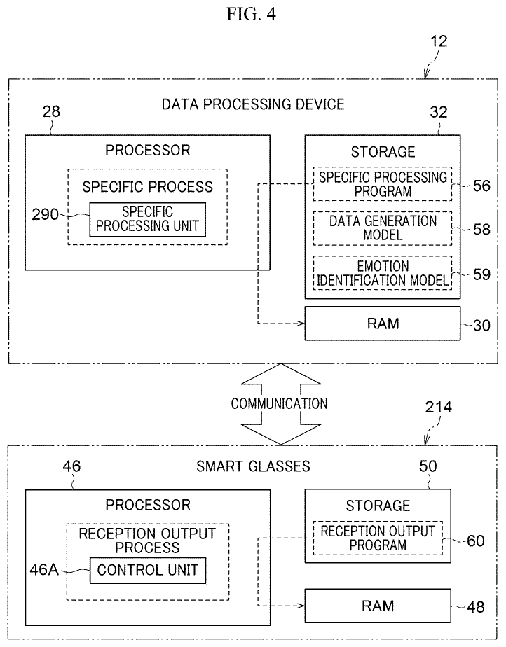

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

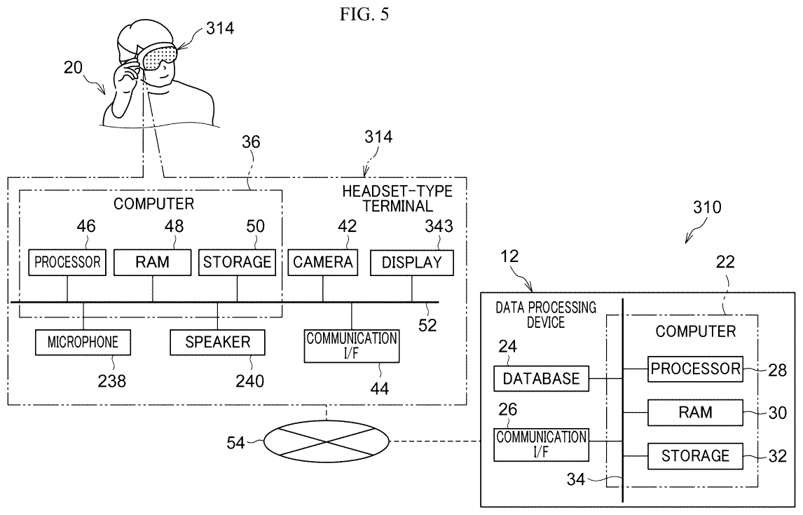

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

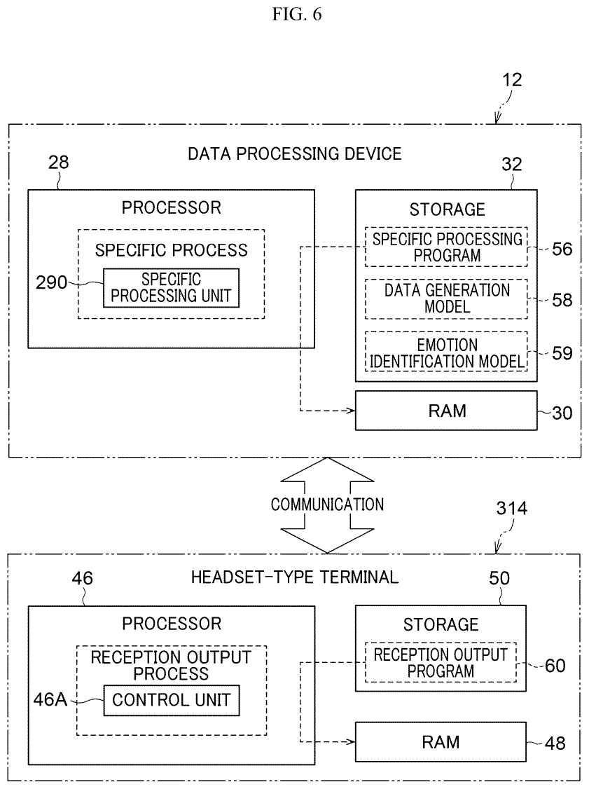

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

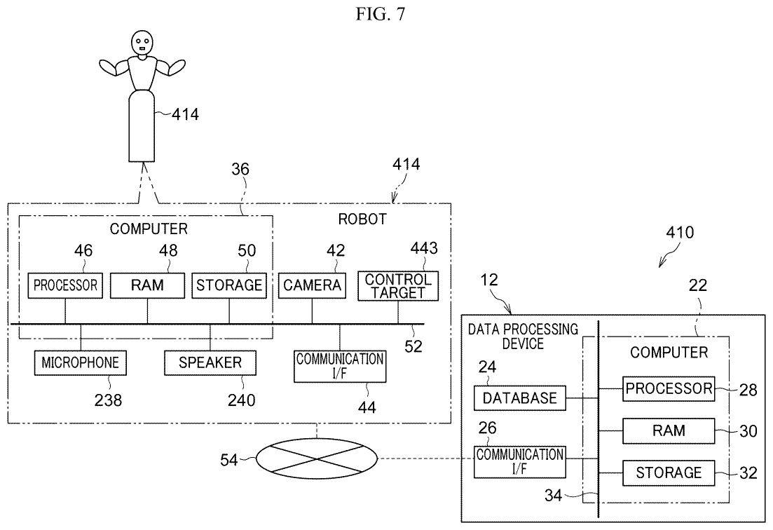

FIG. 7 illustrates an example of a configuration of a data processing system 410 according to a fourth exemplary embodiment.

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

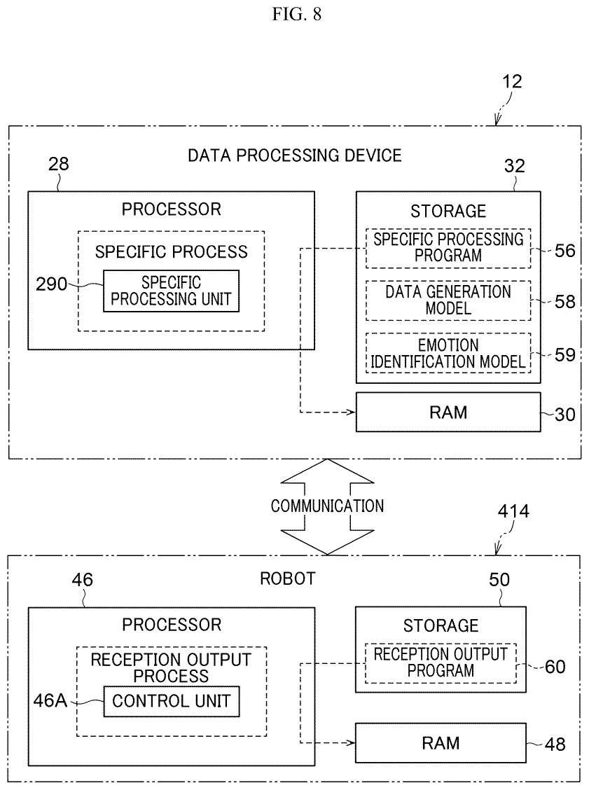

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

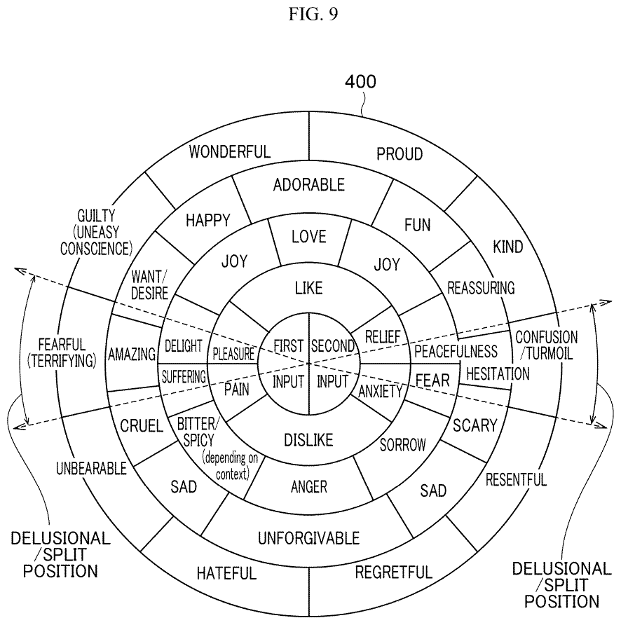

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

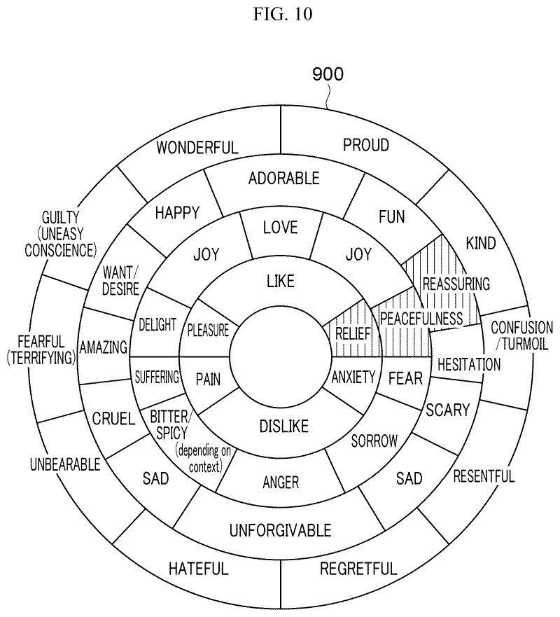

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,

wherein the processor is configured to

receive, via a communication process, charge information relating to a service provided by an external provider from a terminal operated by a user, and record the charge information in an information management mechanism on an information storage device,

acquire the recorded charge information and a plurality of rate structure information items relating to services provided by an internal provider, perform fee calculation for each of the plurality of rate structures by using a numerical computation program group, and identify, by comparison with a fee of the external provider based on the charge information, a rate structure that is most economical for the user,

generate configuration information of a proposal document based on the identified rate structure and a result of the fee calculation, and output, in an electronic format, the proposal document by using an electronic document generation program group,

generate, based on the charge information, the result of the fee calculation, and the identified rate structure, a prompt sentence including instruction content for a generative information processing model, input the prompt sentence to the generative information processing model so as to cause the generative information processing model to generate explanatory text or recommendation content to be described in the proposal document, and enhance content of the proposal document by incorporating the explanatory text or the recommendation content, and

transmit the proposal document in the electronic format to the terminal so that the user is enabled to view the proposal document on the terminal.

### (Supplementary 2)

The system according to supplementary 1,

wherein the processor is configured to, when it is determined, based on the result of the fee calculation, that a relative discount process is required in order to apply the most economical rate structure, cooperate with an internal business processing mechanism, automatically generate an approval request electronic document, and transmit the approval request electronic document to the internal business processing mechanism.

### (Supplementary 3)

The system according to supplementary 1,

wherein the processor is configured to analyze response information of the user acquired via the terminal, estimate an emotional state of the user by emotion analysis processing, and dynamically adjust at least one of the prompt sentence input to the generative information processing model and the configuration information of the proposal document based on a result of the estimation.

### Application Example 1

### (Supplementary 1)

A system comprising a processor,

wherein the processor is configured to

acquire billing information related to a plurality of electronic payment services used by a user, store the billing information as structured data in a storage device, and verify validity of the billing information,

obtain the billing information and a plurality of in-house tariff plan information stored in the storage device, normalize a usage pattern based on the billing information for each item of the in-house tariff plan information, perform fee simulation for each item of the in-house tariff plan information, select a most economical tariff plan from among the plurality of in-house tariff plan information, and calculate comparison information including a usage status of an external service,

generate proposal structured data including proposal content based on the selected tariff plan and the comparison information, and generate a skeletal proposal text in natural language by performing template processing or rule-based processing using the proposal structured data, generate a generation input sentence including situation description information based on the proposal structured data and the skeletal proposal text, generate a prompt sentence for inputting the generation input sentence into a generative AI model, and acquire natural language text output from the generative AI model to supplement or revise content of a proposal document, and

transmit the proposal document and a user-oriented prompt sentence generated by the generative AI model to a terminal device, and record a selection result based on selection information received from the terminal device.

### (Supplementary 2)

The system according to supplementary 1,

wherein the processor is configured to, when it is determined that a relative discount condition is potentially applicable in the selected tariff plan, automatically generate discount approval request data based on the proposal structured data and the comparison information, transmit the discount approval request data to an internal business processing system to initiate an approval procedure, and manage an approval state associated with the discount approval request data.

### (Supplementary 3)

The system according to supplementary 1,

wherein the processor is configured to estimate user state information by analyzing user operation history information or response text information acquired from the terminal device, and add the user state information to the situation description information in the generation input sentence so as to dynamically adjust an expression content or a presentation level of the proposal document and the user-oriented prompt sentence generated by the generative AI model.

### Example 2

### (Supplementary 1)

A system comprising a processor and a storage device,

wherein the processor is configured to

acquire and store, in the storage device, information relating to offerings provided by other organizations, and compare the information relating to offerings provided by the other organizations with information relating to offerings provided by an own organization to calculate candidate pricing schemes, and

receive data of a proposal document, extract character information and numerical information from the proposal document, and identify, as structured data, price information, condition information, and discount information in the proposal document by using natural language processing technology, and

determine, on the basis of the structured data and the information relating to offerings provided by the other organizations and the information relating to offerings provided by the own organization, whether a relative adjustment of the pricing scheme is required, and

generate a prompt sentence to be input to a generative AI model for analysis target data including the structured data, the information relating to offerings provided by the other organizations, and the information relating to offerings provided by the own organization, transmit the prompt sentence and the analysis target data to the generative AI model, and obtain an analysis result relating to contents of the proposal document and the pricing scheme from the generative AI model, and

automatically generate or supplement a proposal document including an optimal pricing scheme on the basis of the analysis result and a determination result of whether the relative adjustment of the pricing scheme is required, and

automatically generate approval request data including a discount rate, a discount reason, and a discount period, and transmit the approval request data to an internal business system, when it is determined, on the basis of the analysis result and the determination result, that the relative adjustment of the pricing scheme is required, and

record the proposal document, the analysis result, and the approval request data in association with one another, and provide information based on the proposal document, the analysis result, and the approval request data to a user terminal.

### (Supplementary 2)

The system according to supplementary 1,

wherein the processor is configured to include, in the prompt sentence to be transmitted to the generative AI model, the candidate pricing schemes, a summary of the information relating to offerings provided by the other organizations, and a summary of the information relating to offerings provided by the own organization, so as to cause the generative AI model to perform competitiveness evaluation of the pricing scheme and generation of a discount proposal.

### (Supplementary 3)

The system according to supplementary 1,

wherein the processor is configured to dynamically change a prompt sentence for re-analysis to be supplied to the generative AI model in response to an input operation from the user terminal, and update the proposal document and the approval request data on the basis of a re-analysis result obtained from the generative AI model.

### Application Example 2

### (Supplementary 1)

A system comprising a processor,

wherein the processor is configured to

acquire billing information regarding a service provided by another provider from a storage medium, store the billing information in a data storage device, analyze the billing information, and calculate, from among a plurality of pricing schemes provided by an own provider, a pricing scheme having high economic efficiency for a user, and

generate structured data including the billing information and information regarding the plurality of pricing schemes, calculate a pricing comparison result and a necessity of discount based on the structured data, and generate skeleton information of a proposal document based on the pricing comparison result, and

generate draft text of the proposal document by executing template processing and natural language processing using the skeleton information of the proposal document, and dynamically generate a prompt sentence to be input to a generative artificial intelligence model based on at least one of the billing information, the pricing comparison result, the necessity of discount, and the draft text, input the prompt sentence and the skeleton information of the proposal document to the generative artificial intelligence model, obtain output text for reinforcing explanatory content or expression content of the proposal document from the generative artificial intelligence model, and incorporate the output text into the proposal document, and

generate the proposal document in an electronic file format and transmit the electronic file via a communication unit to a user terminal or a client terminal.

### (Supplementary 2)

The system according to supplementary 1,

wherein the processor is configured to

determine a necessity of discount approval based on a discount rate calculated from the billing information and the pricing comparison result and on threshold information stored as internal rules, when the discount approval is determined to be necessary, generate approval request data including at least the pricing comparison result and the output text obtained from the generative artificial intelligence model, automatically transmit the approval request data to a business processing system to start an approval workflow, obtain an approval result from the business processing system, and update pricing conditions described in the proposal document based on the approval result.

### (Supplementary 3)

The system according to supplementary 1,

wherein the processor is configured to

execute emotion analysis processing on at least one of text information, voice information, and image information acquired from the user to estimate an emotion state of the user, and, based on the emotion state and the pricing comparison result, dynamically adjust at least one of content of the prompt sentence to be input to the generative artificial intelligence model, a level of detail, tone, and emphasis items of explanatory text in the proposal document, and generate a proposal document in which at least one of a discount rate, an expression of a proposal reason, and an amount of presented information is changed according to the emotion state.

What is claimed is:

1. A system comprising:
circuitry configured to:
receive, via a communication interface coupled to a packet-switched network, a set of external data records from a remote terminal, and store the external data records in a data management mechanism on a storage device;
acquire the stored external data records together with a plurality of parameter sets maintained in the storage device, perform numerical computation for each parameter set of the plurality of parameter sets, and identify, by comparison with a reference value derived from the external data records, a parameter set that satisfies a predetermined optimization criterion;
generate configuration data for a structured output document based on the identified parameter set and a result of the numerical computation, and render the structured output document in an electronic format by using a document generation program module; and
construct, based on the external data records, the result of the numerical computation, and the identified parameter set, a prompt data structure including instruction content for a generative information processing model, and supply the prompt data structure to the generative information processing model to cause the generative information processing model to produce supplemental content to be incorporated into the structured output document, and transmit the structured output document as a notification data packet to the remote terminal via the communication interface.

2. The system according to claim 1, wherein each parameter set of the plurality of parameter sets includes a base value and one or more variable coefficients, and the circuitry is configured to compute, for each parameter set, an estimated aggregate value by applying the base value and the one or more variable coefficients to usage metrics derived from the external data records.

3. The system according to claim 2, wherein the circuitry is configured to identify the parameter set that satisfies the predetermined optimization criterion by determining an index within an array of estimated aggregate values that corresponds to a minimum value.

4. The system according to claim 3, wherein the circuitry is configured to compute, for each parameter set, a differential value representing a difference between the reference value and the estimated aggregate value, and to include the differential value in the configuration data for the structured output document.

5. The system according to claim 1, wherein the circuitry is configured to construct the prompt data structure by concatenating a static instruction template with dynamic fields populated from the result of the numerical computation, such that the generative information processing model produces the supplemental content constrained by the result of the numerical computation.

6. The system according to claim 5, wherein the circuitry is configured to perform post-processing on the supplemental content produced by the generative information processing model by verifying that numerical tokens in the supplemental content match corresponding values in the result of the numerical computation.

7. The system according to claim 1, wherein the circuitry is configured to, when a determination is made from the result of the numerical computation that an adjustment process is required, automatically generate an approval request data structure and transmit the approval request data structure to an internal workflow processing mechanism via the communication interface.

8. The system according to claim 7, wherein the approval request data structure includes at least an identifier of the identified parameter set, a proposed adjustment magnitude, and a justification field derived from the result of the numerical computation.

9. The system according to claim 7, wherein the circuitry is configured to receive an approval result from the internal workflow processing mechanism and update the configuration data of the structured output document based on the approval result.

10. The system according to claim 1, wherein the circuitry is configured to acquire user interaction data from the remote terminal, perform affective state estimation processing on the user interaction data to estimate an emotional state of a user, and dynamically adjust at least one of the prompt data structure and the configuration data of the structured output document based on the estimated emotional state.

11. The system according to claim 10, wherein the affective state estimation processing includes applying a trained classifier to tokenized text data received from the remote terminal to produce a probability distribution over a plurality of affective state categories.

12. The system according to claim 10, wherein the circuitry is configured to, when the estimated emotional state indicates a state of confusion, modify the prompt data structure to instruct the generative information processing model to produce supplemental content with increased granularity and simplified terminology.

13. The system according to claim 1, wherein the external data records relate to billing information of an external service provider, each parameter set of the plurality of parameter sets corresponds to a pricing plan provided by an internal organization, and the predetermined optimization criterion is a lowest estimated cost for the user.

14. The system according to claim 13, wherein the structured output document is a proposal document presenting the identified pricing plan, a simulated fee comparison, and the supplemental content generated by the generative information processing model.

15. The system according to claim 1, wherein the circuitry is configured to generate a skeletal text representation of the structured output document by performing template-based processing on the configuration data prior to supplying the prompt data structure to the generative information processing model.

16. The system according to claim 15, wherein the circuitry is configured to generate a generation input sequence by combining situation description information derived from the configuration data with the skeletal text representation, and to include the generation input sequence within the prompt data structure.

17. The system according to claim 1, wherein the circuitry is configured to receive the external data records in a structured payload format from the remote terminal, validate the external data records by performing schema verification and range checking, and normalize the external data records into a standardized representation prior to performing the numerical computation.

18. A system comprising:
circuitry configured to:
receive, via a communication interface coupled to a packet-switched network, a set of external data records from a remote terminal, and store the external data records in a data management mechanism on a storage device;
acquire the stored external data records together with a plurality of parameter sets maintained in the storage device, perform numerical computation for each parameter set of the plurality of parameter sets, and identify, by comparison with a reference value derived from the external data records, a parameter set that satisfies a predetermined optimization criterion;
generate configuration data for a structured output document based on the identified parameter set and a result of the numerical computation, and render the structured output document in an electronic format by using a document generation program module;
construct, based on the external data records, the result of the numerical computation, and the identified parameter set, a prompt data structure including instruction content for a generative information processing model, and supply the prompt data structure to the generative information processing model to cause the generative information processing model to produce supplemental content to be incorporated into the structured output document;
transmit the structured output document as a notification data packet to the remote terminal via the communication interface;
when a determination is made from the result of the numerical computation that an adjustment process is required, automatically generate an approval request data structure and transmit the approval request data structure to an internal workflow processing mechanism; and
acquire user interaction data from the remote terminal, perform affective state estimation processing on the user interaction data to estimate an emotional state of a user, and
dynamically adjust at least one of the prompt data structure and the configuration data of the structured output document based on the estimated emotional state.

19. The system according to claim 18, wherein the external data records relate to billing information of an external service provider, each parameter set corresponds to a pricing plan, and the circuitry is configured to dynamically adjust the prompt data structure to instruct the generative information processing model to produce supplemental content with a level of detail and a tone adapted to the estimated emotional state.

20. A method performed by circuitry, the method comprising:
receiving, via a communication interface coupled to a packet-switched network, a set of external data records from a remote terminal, and storing the external data records in a data management mechanism on a storage device;
acquiring the stored external data records together with a plurality of parameter sets maintained in the storage device, performing numerical computation for each parameter set of the plurality of parameter sets, and identifying, by comparison with a reference value derived from the external data records, a parameter set that satisfies a predetermined optimization criterion;
generating configuration data for a structured output document based on the identified parameter set and a result of the numerical computation, and rendering the structured output document in an electronic format by using a document generation program module;
constructing, based on the external data records, the result of the numerical computation, and the identified parameter set, a prompt data structure including instruction content for a generative information processing model, and supplying the prompt data structure to the generative information processing model to cause the generative information processing model to produce supplemental content to be incorporated into the structured output document; and
transmitting the structured output document as a notification data packet to the remote terminal via the communication interface.
